(19) United States
(12) Patent Application Publication
(10) Pub. No.: US 2025/0076624 A1
(43) Pub. Date: Mar. 6, 2025

(54) ZOOM LENS AND IMAGING APPARATUS

(71) Applicant: FUJIFILM Corporation, Tokyo (JP)

(72) Inventors: Toshihiro AOI, Saitama-shi (JP); Ukyo TOMIOKA, Saitama-shi (JP); Kazuyoshi OKADA, Saitama-shi (JP); Masanao KAWANA, Saitama-shi (JP)

(73) Assignee: FUJIFILM Corporation, Tokyo (JP)

(21) Appl. No.: 18/812,565

(22) Filed: Aug. 22, 2024

(30) Foreign Application Priority Data
Aug. 30, 2023 (JP) 2023-140487

(51) Int. Cl. G02B 15/14; G02B 13/18; G02B 27/00

(52) U.S. Cl. CPC G02B 15/145121; G02B 13/18; G02B 27/0068

(57) ABSTRACT

The zoom lens consists of, in order from an object side to an image side, a front group, an intermediate group, and a rear group. The front group consists of two or fewer lens groups that have positive refractive powers. A lens group closest to the object side in the front group remains stationary with respect to an image plane during zooming. The intermediate group consists of two or fewer lens groups that have negative refractive powers. The rear group consists of a plurality of lens groups. A lens group closest to the object side in the rear group has a positive refractive power, and a lens group closest to the image side in the rear group remains stationary with respect to the image plane during zooming. During zooming, all the spacings of adjacent lens groups change. The zoom lens satisfies predetermined conditional expressions.

### CROSS-REFERENCE TO RELATED APPLICATIONS

This application claims priority from Japanese Patent Application No. 2023-140487, filed on Aug. 30, 2023, the entire disclosure of which is incorporated herein by reference.

### BACKGROUND

### Technical Field

The technique of the present disclosure relates to a zoom lens and an imaging apparatus.

### Related Art

In the related art, as a zoom lens having a long focal length on the telephoto side, for example, a zoom lens disclosed in JP2020-064153A is known.

### SUMMARY

There is a demand for a zoom lens that is configured to have a small size, that has a high zoom ratio, and that maintains favorable optical performance. The demand level is increasing year by year.

The present disclosure provides a zoom lens that is configured to have a small size, that has a high zoom ratio, and that maintains favorable optical performance, and an imaging apparatus comprising the zoom lens.

According to one aspect of the present disclosure, there is provided a zoom lens consisting of, in order from an object side to an image side, a front group, an intermediate group, and a rear group, in which the front group consists of a lens group that has two or fewer positive refractive powers, the lens group closest to the object side in the front group remains stationary with respect to an image plane during zooming, the intermediate group consists of a lens group that has two or fewer negative refractive powers, the rear group consists of a plurality of lens groups, the lens group closest to the object side in the rear group has a positive refractive power, and the lens group closest to the image side in the rear group remains stationary with respect to the image plane during zooming, all spacings of adjacent lens groups change during zooming, and Conditional Expression (1) is satisfied, which is represented by

$$0.4 < ( ft / fw ) / Mov max . \qquad ( 1 )$$

Here, it is assumed that a focal length of the whole system in a state where the infinite distance object is in focus at the telephoto end is ft. It is assumed that a focal length of the whole system in a state where the infinite distance object is in focus at the wide-angle end is fw. It is assumed that an amount of displacement of a lens group, which has a maximum amount of displacement during zooming from the wide-angle end to the telephoto end, among lens groups that move during zooming, is Movmax. The unit of Movmax is millimeter (mm).

Assuming that a sum of a back focal length of the whole system in terms of an air-equivalent distance and a distance on an optical axis from a lens surface closest to the object side in the front group to a lens surface closest to the image side in the rear group in a state where the infinite distance object is in focus is TL, and a maximum image height is Y, it is preferable that the zoom lens of the above-mentioned aspect satisfies Conditional Expression (2), which is represented by

$$TL / 2 Y < 80. \qquad ( 2 )$$

It is preferable that the zoom lens of the above-mentioned aspect satisfies Conditional Expression (1-1), which is represented by

$$0.8 < ( ft / fw ) / Mov max . \qquad ( 1 - 1 )$$

Assuming that a sum of a back focal length of the whole system in terms of an air-equivalent distance and a distance on an optical axis from a lens surface closest to the object side in the front group to a lens surface closest to the image side in the rear group in a state where the infinite distance object is in focus is TL, it is preferable that the zoom lens of the above-mentioned aspect satisfies Conditional Expression (3), which is represented by

$$2 < ft / TL . \qquad ( 3 )$$

Assuming that a back focal length of the whole system in terms of an air-equivalent distance is Bf, it is preferable that the zoom lens of the above-mentioned aspect satisfies Conditional Expression (4), which is represented by

$$10 < ft / Bf . \qquad ( 4 )$$

Assuming that a maximum image height is Y, it is preferable that the zoom lens of the above-mentioned aspect satisfies Conditional Expression (5), which is represented by

$$30 < ft / 2 Y . \qquad ( 5 )$$

Assuming that a focal length of the lens group closest to the object side in the front group is fF1, it is preferable that the zoom lens of the above-mentioned aspect satisfies Conditional Expression (6), which is represented by

$$0.5 < ft / fF 1. \qquad ( 6 )$$

Assuming that a focal length of a lens group closest to the object side in the intermediate group is fM1, it is preferable that the zoom lens of the above-mentioned aspect satisfies Conditional Expression (7), which is represented by

$$5 < \vert ft / fM 1 \vert . \qquad ( 7 )$$

It is preferable that the lens group closest to the object side in the front group includes at least four lenses, and a lens group which is third from the object side in the rear group includes an aspherical lens.

Assuming that a focal length of the lens group closest to the object side in the rear group is fR1, it is preferable that the zoom lens of the above-mentioned aspect satisfies Conditional Expression (8), which is represented by

$$0 < ft / fR 1 < 100. \qquad ( 8 )$$

Assuming that a focal length of the lens group closest to the image side in the rear group is fRe, it is preferable that the zoom lens of the above-mentioned aspect satisfies Conditional Expression (9), which is represented by

$$- 100 < ft / fRe < 200. \qquad ( 9 )$$

In addition, the zoom lens of the above-mentioned aspect may be configured to satisfy Conditional Expression (9-1), which is represented by

$$0 < ft / fRe < 200. \qquad ( 9 - 1 )$$

The zoom lens may be configured to satisfy Conditional Expression (9-6), which is represented by

$$- 100 < ft / fRe < 0. \qquad ( 9 - 6 )$$

In a configuration in which the zoom lens includes a focusing group that moves during focusing, assuming that a lateral magnification of the focusing group in a state where the infinite distance object is in focus at the telephoto end is βfoc, and a combined lateral magnification of all lenses closer to the image side than the focusing group in a state where the infinite distance object is in focus at the telephoto end is βfocR, it is preferable that the zoom lens of the above-mentioned aspect satisfies Conditional Expression (10), which is represented by

$$\vert ( 1 - β {foc}^{2} ) \times β {focR}^{2} \vert < 50. \qquad ( 10 )$$

It is preferable that the lens group closest to the object side in the front group includes at least one cemented lens.

It is preferable that the lens group closest to the object side in the front group includes at least one positive lens that has an Abbe number of 70 or more based on a d-line.

It is preferable that the lens group closest to the object side in the front group includes at least one negative lens that has an Abbe number of 60 or less based on a d-line.

It is preferable that a lens group closest to the object side in the intermediate group includes at least one positive lens that has an Abbe number of 40 or less based on a d-line.

It is preferable that a lens group closest to the object side in the intermediate group includes at least one positive lens and at least two negative lenses.

According to another aspect of the present disclosure, there is provided an imaging apparatus comprising the zoom lens of the above-mentioned aspect.

In the present specification, it should be noted that the terms “consisting of” and “consists of” mean that the lens may include not only the above-mentioned components but also lenses substantially having no refractive powers, optical elements, which are not lenses, such as a stop, a filter, and a cover glass, and mechanism parts such as a lens flange, a lens barrel, an imaging element, and a camera shaking correction mechanism.

In the present specification, the terms “group that has a positive refractive power” and “group has a positive refractive power” mean that the group as a whole has a positive refractive power. Similarly, the terms “group that has a negative refractive power” and “group has a negative refractive power” mean that the group as a whole has a negative refractive power. The term “a lens that has a positive refractive power” and the term “a positive lens” are synonymous. The term “a lens that has a negative refractive power” and the term “negative lens” are synonymous. The term “group” in the present specification is not limited to a configuration consisting of a plurality of lenses, but may be a configuration consisting of only one lens.

A compound aspherical lens (in which a lens (for example, a spherical lens) and an aspherical film formed on the lens are integrally formed and function as one aspherical lens as a whole) is not regarded as cemented lenses, but the compound aspherical lens is regarded as one lens. The sign of the refractive power and the surface shape of the lens including the aspherical surface will be used in terms of the paraxial region unless otherwise specified.

The term “whole system” in the present specification means a zoom lens. The term “back focal length in terms of the air-equivalent distance” means the air-equivalent distance on the optical axis from the lens surface closest to the image side in the whole system to the image plane. The term “a single lens” means one lens that is not cemented. The term “focal length” used in a conditional expression means a paraxial focal length. Unless otherwise specified, the term “distance on the optical axis” used in Conditional Expression means a geometrical distance. The values used in the conditional expressions are values in a case where the d-line is used as a reference in a state where the infinite distance object is in focus unless otherwise specified.

According to the present disclosure, it is possible to provide a zoom lens that is configured to have a small size, that has a high zoom ratio, and that maintains favorable optical performance, and an imaging apparatus comprising the zoom lens.

### BRIEF DESCRIPTION OF THE DRAWINGS

FIG. 1 is a cross-sectional view showing a configuration of a zoom lens according to an embodiment and a diagram showing movement loci thereof, the zoom lens corresponding to a zoom lens of Example 1.

FIG. 2 is a cross-sectional view showing a configuration and luminous flux in each zooming state of the zoom lens of FIG. 1 and a diagram for explaining symbols of conditional expressions.

FIG. 3 is a diagram showing aberrations of the zoom lens of Example 1.

FIG. 4 is a cross-sectional view of a configuration of a zoom lens of Example 2 and a diagram showing movement loci thereof.

FIG. 5 is a diagram showing aberrations of the zoom lens of Example 2.

FIG. 6 is a cross-sectional view of a configuration of a zoom lens of Example 3 and a diagram showing movement loci thereof.

FIG. 7 is a diagram showing a configuration and luminous flux of the zoom lens of Example 3 in each zooming state.

FIG. 8 is a cross-sectional view of a configuration of a zoom lens of Example 4 and a diagram showing movement loci thereof.

FIG. 9 is a diagram showing aberrations of the zoom lens of Example 4.

FIG. 10 is a cross-sectional view of a configuration of a zoom lens of Example 5 and a diagram showing movement loci thereof.

FIG. 11 is a diagram showing aberrations of the zoom lens of Example 5.

FIG. 12 is a cross-sectional view of a configuration of a zoom lens of Example 6 and a diagram showing movement loci thereof.

FIG. 13 is a diagram showing aberrations of the zoom lens of Example 6.

FIG. 14 is a cross-sectional view of a configuration of a zoom lens of Example 7 and a diagram showing movement loci thereof.

FIG. 15 is a diagram showing aberrations of the zoom lens of Example 7.

FIG. 16 is a cross-sectional view of a configuration of a zoom lens of Example 8 and a diagram showing movement loci thereof.

FIG. 17 is a diagram showing aberrations of the zoom lens of Example 8.

FIG. 18 is a schematic configuration diagram of an imaging apparatus according to an embodiment.

### DESCRIPTION OF EMBODIMENTS

Hereinafter, embodiments of the present disclosure will be described with reference to the accompanying drawings.

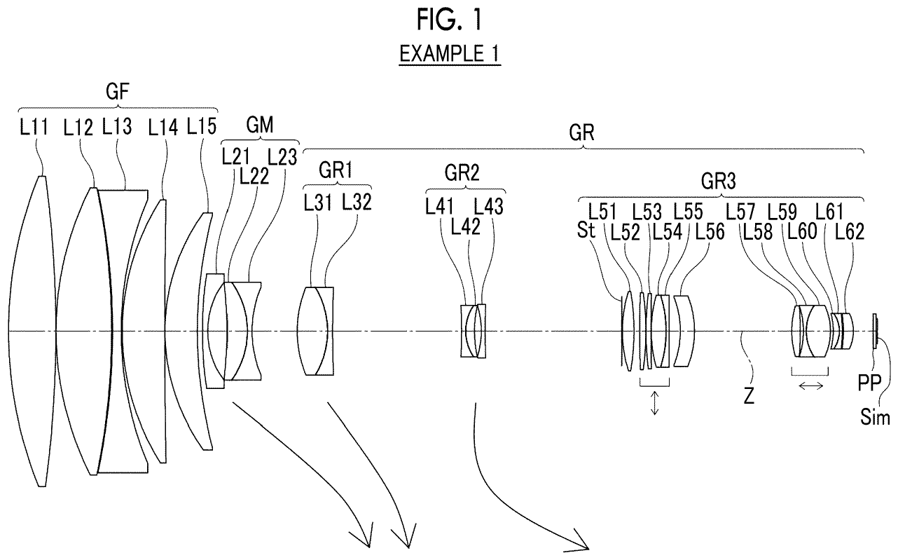

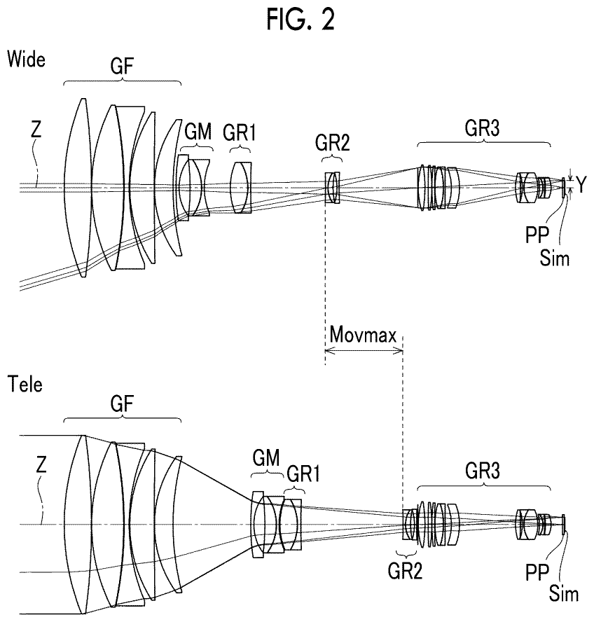

FIG. 1 shows a cross-sectional view of a configuration of a zoom lens according to an embodiment of the present disclosure. In FIG. 1, an arrow indicating a schematic movement locus of each group during zooming from the wide-angle end to the telephoto end is also shown under each group that moves during zooming. FIG. 2 shows a diagram in which the luminous flux is shown together with a cross-sectional view of the configuration of the zoom lens of FIG. 1. In FIG. 2, the upper part labeled “Wide” shows a wide-angle end state, and the lower part labeled “Tele” shows a telephoto end state. FIG. 2 shows, as the luminous flux, the on-axis luminous flux and the luminous flux at the maximum half angle of view in each state. Examples shown in FIGS. 1 and 2 correspond to a zoom lens of Example 1 to be described later. FIGS. 1 and 2 show situations where an infinite distance object is in focus, the left side thereof is an object side, and the right side thereof is an image side. Hereinafter, description will be given mainly with reference to FIG. 1 and will be given with reference to FIG. 2 as necessary.

FIG. 1 shows an example in which, assuming that a zoom lens is applied to an imaging apparatus, an optical member PP having a parallel plate shape is disposed between the zoom lens and an image plane Sim. The optical member PP is a member assumed to include various filters, a cover glass, and/or the like. The various filters include a low pass filter, an infrared cut filter, and/or a filter that cuts a specific wavelength region. The optical member PP is a member that has no refractive power. It is also possible to configure the imaging apparatus by removing the optical member PP.

The zoom lens of the present disclosure consists of a front group GF, an intermediate group GM, and a rear group GR, in order from the object side to the image side along an optical axis Z. The front group GF consists of two or fewer lens groups that have positive refractive powers. The intermediate group GM consists of two or fewer lens groups that have negative refractive powers. The rear group GR consists of a plurality of lens groups. During zooming, all the spacings of adjacent lens groups change.

By adopting a configuration of the front group GF with one lens group or two lens groups that have positive refractive powers, it is easy to increase the focal length at the telephoto side. By adopting a configuration of the intermediate group GM with one lens group or two lens groups that have negative refractive powers, it is easy to shorten the focal length at the wide-angle end. With the above-mentioned configuration of the front group GF and the intermediate group GM, it is easy to realize the zoom lens having a high zoom ratio.

In the present specification, a group, in which a spacing between the group and an adjacent group thereof changes in the optical axis direction during zooming, is set as one lens group. During zooming, spacing between adjacent lenses does not change inside one lens group. The term “lens group” in the present specification means a part including the at least one lens, which is a constituent part of the zoom lens and is divided by an air spacing that changes during zooming. During zooming, each lens group as a unit moves or remains stationary. It should be noted that the “lens group” may include a constituent element other than a lens having no refractive power such as the aperture stop St.

In the zoom lens of the present disclosure, the lens group closest to the object side in the front group GF remains stationary with respect to the image plane Sim during zooming. By keeping the lens group closest to the object side in the zoom lens stationary during zooming, a total length of the lens system does not change during zooming. Therefore, it is easy to make a device configuration in which the zoom lens is housed in a housing. Further, even in a case where the imaging apparatus is installed outdoors or even in a case where the imaging apparatus is housed in a waterproof case or the like, it is easy to perform imaging in a range from the telephoto end to the wide-angle end without vignetting.

Further, in the zoom lens of the present disclosure, the lens group closest to the image side in the rear group GR remains stationary with respect to the image plane Sim during zooming. With such a configuration, it is possible to manufacture an optical element without significantly changing a direction of passing of the ray through the rear group GR. Therefore, it is easy to obtain stable performance in a range from the wide-angle end to the telephoto end. Further, by adopting a configuration of the lens group closest to the image side in the rear group GR to remain stationary during zooming, it is easy to prevent entry of dust or the like into the zoom lens.

For example, each group of the zoom lens shown in FIG. 1 is configured as follows. The front group GF consists of one lens group that has a positive refractive power. The intermediate group GM consists of one lens group that has a negative refractive power. The rear group GR consists of, in order from the object side to the image side, three lens groups including a first subsequent lens group GR1 that has a positive refractive power, a second subsequent lens group GR2 that has a negative refractive power, and a third subsequent lens group GR3 that has a positive refractive power. During zooming, the front group GF and the third subsequent lens group GR3 remain stationary with respect to the image plane Sim, and the intermediate group GM, the first subsequent lens group GR1, and the second subsequent lens group GR2 move along the optical axis Z by changing spacings between the adjacent lens groups. With such a configuration, it is possible to provide a high-performance zoom lens that has a small size and corrects various aberrations over a zoom range while making a focal length at the telephoto end sufficiently long.

Further, as an example, the elements constituting the lens groups in FIG. 1 are as follows. The lens groups, which constitute the front group GF, consist of five lenses L11 to L15, in order from the object side to the image side. The lens group, which constitutes the intermediate group GM, consists of three lenses L21 to L23, in order from the object side to the image side. The first subsequent lens group GR1 consists of two lenses L31 and L32, in order from the object side to the image side. The second subsequent lens group GR2 consists of three lenses L41 to L43, in order from the object side to the image side. The third subsequent lens group GR3 consists of an aperture stop St and twelve lenses L51 to L62, in order from the object side to the image side. The aperture stop St shown in FIG. 1 does not show the size or the shape thereof, but shows a position thereof in the optical axis direction.

The zoom lens of FIG. 1 includes a focusing group that moves during focusing. Hereinafter, the group that moves along the optical axis Z during focusing is referred to as the focusing group. Focusing is performed by moving the focusing group. For example, in the example of FIG. 1, the focusing group consists of three lenses L57 to L59 of the third subsequent lens group GR3. In FIG. 1, both horizontal arrows are noted in parentheses under the lens corresponding to the focusing group.

Further, the zoom lens of FIG. 1 includes a vibration-proof group that moves during image blur correction. Hereinafter, the group, which moves in the direction intersecting with the optical axis Z during the image blur correction, will be referred to as the vibration-proof group. The image blur correction is performed by moving the vibration-proof group. For example, in the example of FIG. 1, the vibration-proof group consists of four lenses L52 to L55 of the third subsequent lens group GR3. In FIG. 1, both vertical arrows are noted in parentheses below the lens corresponding to the vibration-proof group.

It is preferable that a lens group closest to the object side in the front group GF has a positive refractive power. In such a case, it is easy to make a configuration of the optical system to have a small size while having a telephoto type.

It is preferable that the lens group closest to the object side in the front group GF includes at least two lenses. By using two or more lenses in the lens group closest to the object side in the front group GF, it is easy to correct chromatic aberration. Thus, there is an advantage in achieving an increase in resolution. It is more preferable that the lens group closest to the object side in the front group GF includes at least four lenses. By using four or more lenses in the lens group closest to the object side in the front group GF, it is easier to correct chromatic aberration. Thus, there is an advantage in achieving an increase in resolution.

It is preferable that the lens group closest to the object side in the front group GF includes at least two positive lenses. In such a case, it is easy to increase the positive refractive power of the lens group closest to the object side in the front group GF. Thus, there is an advantage in achieving reduction in size.

It is preferable that the lens group closest to the object side in the front group GF includes at least one positive lens that has an Abbe number of 70 or more based on a d-line. In such a case, it is easy to correct chromatic aberration. Thus, there is an advantage in achieving an increase in resolution.

It is preferable that the lens group closest to the object side in the front group GF includes at least one negative lens. In such a case, it is easy to correct chromatic aberration. Thus, there is an advantage in achieving an increase in resolution.

It is preferable that the lens group closest to the object side in the front group GF includes at least one negative lens that has an Abbe number of 60 or less based on the d-line. In such a case, it is easy to correct chromatic aberration. Thus, there is an advantage in achieving an increase in resolution. It is more preferable that the lens group closest to the object side in the front group GF includes at least one negative lens that has an Abbe number of 40 or less based on the d-line. In such a case, it is easier to correct chromatic aberration. Thus, there is an advantage in achieving an increase in resolution.

It is preferable that the lens group closest to the object side in the front group GF includes at least two positive lenses and at least two negative lenses. In such a case, it is easy to correct chromatic aberration. Thus, there is an advantage in achieving an increase in resolution.

It is preferable that the lens group closest to the object side in the front group GF includes at least one cemented lens. In such a case, it is easy to correct chromatic aberration. Thus, there is an advantage in achieving an increase in resolution.

The lens group closest to the object side in the front group GF may be configured to include two cemented lenses. In such a case, there is an advantage in correcting longitudinal chromatic aberration.

It is preferable that the lens group closest to the object side in the front group GF includes a single lens that has a positive refractive power closest to the object side. In such a case, there is an advantage in achieving an increase in focal length and a reduction in size.

It is preferable that the lens group closest to the object side in the front group GF includes an aspherical lens. In such a case, there is an advantage in correcting various aberrations. Thus, there is an advantage in achieving an increase in resolution.

In a case where the lens group closest to the object side in the front group GF includes an aspherical lens, it is preferable that an Abbe number of the aspherical lens based on the d-line is 40 or more. In such a case, it is easy to correct chromatic aberration. Thus, there is an advantage in achieving an increase in resolution.

It is preferable that a lens group, which is second from the object side in the front group GF, moves during zooming. Such a case is advantageous for realizing a zoom lens having a high zoom ratio.

It is preferable that the lens group, which is second from the object side in the front group GF, has a positive refractive power. In such a case, the luminous flux can be converged. Thus, there is an advantage in achieving reduction in total length of the lens system.

The lens group, which is second from the object side in the front group GF, may be configured to consist of one lens. In such a case, there is an advantage in performing zooming at a high speed while achieving reduction in weight. In a case where the lens group, which is second from the object side in the front group GF, consists of one lens, the lens may be configured as a positive lens. In such a case, there is an advantage in achieving a compact configuration of the zoom lens while suppressing fluctuation in aberrations during zooming.

The zoom lens may be configured such that a lens surface closest to the image side in a lens group closest to the object side in the front group GF is a concave surface and a lens surface closest to the object side in a lens group closest to the object side in the intermediate group GM is a convex surface. In such a case, it is easy to satisfactorily correct astigmatism and distortion on the telephoto side.

It is preferable that the lens group closest to the object side in the intermediate group GM has a negative refractive power and moves during zooming. In such a case, it is easy to realize the zoom lens having a high zoom ratio.

It is preferable that the lens group closest to the object side in the intermediate group GM includes at least three lenses. In such a case, it is easy to correct chromatic aberration. Thus, there is an advantage in achieving an increase in resolution. Further, since the refractive power can be shared by the lenses, it is easy to satisfactorily correct various aberrations.

It is preferable that the lens group closest to the object side in the intermediate group GM includes at least one positive lens and at least two negative lenses. By adopting a configuration of the zoom lens to include a combination of positive and negative lenses, it is easy to satisfactorily correct various monochromatic aberrations and chromatic aberration.

It is preferable that the lens group closest to the object side in the intermediate group GM includes a plurality of negative lenses. In such a case, the refractive power of each negative lens can be weakened as compared with a case where the lens group closest to the object side in the intermediate group GM does not include a plurality of negative lenses. Therefore, it is easy to reduce the error sensitivity with respect to eccentricity. Thereby, it is easy to improve the manufacturability.

It is preferable that the lens group closest to the object side in the intermediate group GM includes a plurality of negative lenses, and a cemented lens is configured by cementing at least one negative lens of the plurality of negative lenses to a positive lens. By adopting a configuration of the zoom lens to include a combination of positive and negative lenses, it is easy to satisfactorily correct various monochromatic aberrations and chromatic aberration.

It is preferable that the lens group closest to the object side in the intermediate group GM includes at least one positive lens that has an Abbe number of 40 or less based on the d-line. In such a case, it is easy to correct chromatic aberration. Thus, there is an advantage in achieving an increase in resolution. It is more preferable that the lens group closest to the object side in the intermediate group GM includes at least one positive lens that has an Abbe number of 25 or less based on the d-line. In such a case, it is easier to correct chromatic aberration. Thus, there is an advantage in achieving an increase in resolution.

It is preferable that the lens group closest to the object side in the intermediate group GM includes at least one cemented lens. In such a case, various monochromatic aberrations and chromatic aberrations are easily corrected. Thus, there is an advantage in achieving an increase in resolution.

It is preferable that the lens group closest to the object side in the intermediate group GM includes an aspherical lens. In such a case, there is an advantage in correcting various aberrations. Thus, there is an advantage in achieving an increase in resolution.

In a case where the lens group closest to the object side in the intermediate group GM includes an aspherical lens, it is preferable that an Abbe number of the aspherical lens based on the d-line is 40 or less. In such a case, it is easy to correct chromatic aberration. Thus, there is an advantage in achieving an increase in resolution.

The lens closest to the object side in the lens group closest to the object side in the intermediate group GM may be configured as a positive lens. In such a case, there is an advantage in preventing a diameter of the intermediate group GM from increasing.

It is preferable that an Abbe number of the lens closest to the object side in the lens group closest to the object side in the intermediate group GM based on the d-line is 25 or less. In such a case, there is an advantage in correcting chromatic aberration.

A lens closest to the image side in the lens group closest to the object side in the intermediate group GM may be configured as an aspherical lens. In such a case, there is an advantage in correcting various aberrations. Thus, there is an advantage in achieving an increase in resolution.

It is preferable that the aspherical lens of the lens group closest to the object side in the intermediate group GM is a negative lens. In such a case, it is easy to correct spherical aberration and field curvature.

It is preferable that an object side surface of a lens closest to the image side in a lens group closest to the object side in the intermediate group GM is a concave surface. In such a case, it is easy to correct spherical aberration and field curvature.

The lens group, which is second from the object side in the rear group GR, may be configured such that a whole or a part thereof is a vibration-proof group. The lens group, which is second from the object side in the intermediate group GM, among the lens groups included in the zoom lens is relatively small. Therefore, it is easy to achieve reduction in size of the vibration-proof mechanism by providing the lens group with the vibration-proof function.

A lens group closest to the object side in the rear group GR is configured to have a positive refractive power. Thereby, it is easy to achieve reduction in lens diameter of the rear group GR.

The lens group closest to the object side in the rear group GR may be configured to move during zooming. In such a case, it is possible to suppress fluctuation in spherical aberration during zooming. Thus, there is an advantage in achieving an increase in performance. In a case where the lens group closest to the object side in the rear group GR has a positive refractive power and is configured to move during zooming, it is easy to achieve reduction in size of the lens system. Further, there is an advantage in correcting an image position shift during zooming.

The lens group closest to the object side in the rear group GR may be configured to remain stationary with respect to the image plane Sim during zooming. In such a case, the number of groups that move during zooming can be reduced as compared to a configuration in which the lens group moves. Therefore, it is easy to enhance robustness.

It is preferable that the lens group closest to the object side in the rear group GR includes a plurality of positive lenses. In such a case, it is possible to reduce the refractive power of each positive lens as compared with a case where the lens group closest to the object side in the rear group GR does not include a plurality of positive lenses. Therefore, it is easy to reduce the error sensitivity with respect to eccentricity. Thereby, it is easy to improve the manufacturability.

It is preferable that the lens group closest to the object side in the rear group GR includes at least three positive lenses and at least one negative lens. By adopting a configuration of the zoom lens to include a combination of positive and negative lenses, it is easy to satisfactorily correct various monochromatic aberrations and chromatic aberration.

It is preferable that the lens group closest to the object side in the rear group GR includes at least one cemented lens. In such a case, there is an advantage in correcting chromatic aberration.

It is preferable that the lens group closest to the object side in the rear group GR includes at least one negative lens that has an Abbe number of 35 or less based on the d-line. In such a case, there is an advantage in correcting chromatic aberration.

It is preferable that the lens group closest to the object side in the rear group GR includes an aspherical lens. In such a case, there is an advantage in correcting various aberrations. Thus, there is an advantage in achieving an increase in resolution.

It is preferable that the aspherical lens of the lens group closest to the object side in the rear group GR is a positive lens. In such a case, it is easy to satisfactorily correct spherical aberration.

The lens closest to the image side in the lens group closest to the object side in the rear group GR may be configured as a positive lens. In such a case, it is easy to prevent the diameter of the lens group closer to the image side than the positive lens from increasing. Thus, there is an advantage in achieving reduction in size.

The zoom lens may be configured such that an Abbe number of the lens closest to the image side in the lens group closest to the object side in the rear group GR based on the d-line is 80 or more. In such a case, there is an advantage in correcting chromatic aberration.

An image side surface of the lens closest to the image side in the lens group closest to the object side in the rear group GR may be configured as a convex surface. In such a case, it is easy to prevent the diameter of the lens group closer to the image side than the lens from increasing. Thus, there is an advantage in achieving reduction in size.

The lens group, which is second from the object side in the rear group GR, may be configured to have a negative refractive power and to move during zooming. By making the lens group, which is second from the object side in the rear group GR, to have a negative refractive power, the luminous flux emitted from this group can be divergent light. Therefore, it is easy to correct spherical aberration in a group closer to the image side than the group. Further, by adopting a configuration of the lens group, which is second from the object side in the rear group GR, to move during zooming, there is an advantage in correcting the image position shift during zooming.

It is preferable that the lens group, which is second from the object side in the rear group GR, moves to the image side from the object side during zooming from the wide-angle end to the telephoto end. In such a case, a movement direction of the lens group, which is second from the object side in the rear group GR, during zooming can be made to be the same as the movement direction of the intermediate group GM. Therefore, it is easy to ensure a required amount of movement. As a result, it is easy to shorten the total length of the lens system.

It is preferable that the lens group, which is second from the object side in the rear group GR, includes an aspherical lens. In such a case, there is an advantage in correcting various aberrations. Thus, there is an advantage in achieving an increase in resolution.

It is preferable that the aspherical lens of the lens group, which is second from the object side in the rear group GR, is a negative lens. Since the negative lens has an action of diverging luminous flux, in a case where the focusing group is configured to include the negative lens or a lens closer to the image side than the negative lens, it is easy to ensure the amount of movement during focusing.

It is preferable that a lens group, which is third from the object side in the rear group GR, includes an aspherical lens. In such a case, there is an advantage in correcting various aberrations. Thus, there is an advantage in achieving an increase in resolution.

A lens group closest to the image side in the rear group GR may be configured to have a positive refractive power. In such a case, it is possible to provide a light condensing action to the lens group closest to the image side in the rear group GR. Thus, there is an advantage in achieving reduction in size.

The lens group closest to the image side in the rear group GR may be configured to have a negative refractive power. In such a case, there is an advantage in ensuring the back focal length thereof. Further, it is possible to reduce the refractive power of the lens group that moves during zooming. Thus, there is an advantage in suppressing fluctuation in aberrations during zooming.

A part of the lens group closest to the image side in the rear group GR may be configured as a focusing group. In such a case, it is possible to achieve reduction in weight of the focusing group. Therefore, it is easy to perform focusing at a high speed.

The focusing group may be configured to be included in a lens group that remains stationary with respect to the image plane Sim during zooming in the rear group GR. In such a case, the structure is simple as compared with a case where the lens group is provided to be movable during zooming. Thus, there is an advantage in improving an accuracy of the position control.

Alternatively, the focusing group may be configured to be included in a lens group that moves during zooming in the rear group GR. In such a case, the number of movable groups can be reduced as compared with a case where the lens group is provided to be included in the lens group that remains stationary with respect to the image plane Sim during zooming. Therefore, the mechanical structure is simple. Thus, there is an advantage in achieving reduction in size of the apparatus.

A lens group, which remains stationary with respect to the image plane Sim during zooming in the rear group GR, may be configured to have a negative refractive power. In such a case, there is an advantage in ensuring the back focal length thereof.

The lens group, which remains stationary with respect to the image plane Sim during zooming in the rear group GR, may be configured to consist of, in order from the object side to the image side, a first sub group that remains stationary with respect to the image plane Sim during focusing, a second sub group that moves along the optical axis Z during focusing, and a third sub group that remains stationary with respect to the image plane Sim during focusing. The second sub group is a focusing group. In the above-mentioned configuration, in a case where the first sub group has a negative refractive power, the second sub group has a positive refractive power, and the third sub group has a negative refractive power, there is an advantage in suppressing fluctuation in aberrations during focusing while ensuring the back focal length thereof. Alternatively, in a case where the first sub group has a positive refractive power, the second sub group has a negative refractive power, and the third sub group has a positive refractive power, there is an advantage in suppressing fluctuation in aberrations during focusing while achieving reduction in size.

The lens group, which remains stationary with respect to the image plane Sim during zooming in the rear group GR, includes a focusing group that has a negative refractive power. In such a case, it is preferable that an average value of refractive indexes of all lenses included in the focusing group with respect to a d-line is 1.8 or more. In such a case, there is an advantage in suppressing fluctuation in aberrations during focusing.

The focusing group may be the entirety of any of the lens group closest to the object side in the rear group GR, the lens group which is second from the object side in the rear group GR, and the lens group closest to the image side in the rear group GR, or may be only a part of any of the lens groups. In such a case, it is possible to achieve reduction in size and weight as compared with a case where the focusing group is disposed in the front group GF. Thus, there is an advantage in achieving high-speed focusing.

A part of the lens group closest to the image side in the rear group GR may be a vibration-proof group. Among the lens groups included in the zoom lens, the lens group closest to the image side in the rear group GR is small. Therefore, by providing the lens group with the vibration-proof function, it is easy to achieve reduction in size of a vibration-proof mechanism.

It is preferable that the aperture stop St is disposed in the rear group GR. In such a case, the aperture stop St is disposed at a position closer to the image side in the zoom lens. Therefore, it is easy to separate the on-axis luminous flux and the off-axis luminous flux at a position closer to the object side than the aperture stop St. Thereby, it is easy to suppress astigmatism at the wide-angle end.

It is preferable that two positive lenses are successively disposed closer to the image side than the aperture stop St. In such a case, it is easy to satisfactorily correct spherical aberration. More preferably, the three positive lenses are successively disposed closer to the image side than the aperture stop St. In such a case, it is easier to satisfactorily correct spherical aberration.

Next, preferable and possible configurations about the conditional expressions of the zoom lens of the present disclosure will be described. In the following description of conditional expressions, in order to avoid redundant descriptions, the same symbols are used for those having the same definition, and some duplicate descriptions of the symbols will not be repeated. Further, in the following description, the term “zoom lens according to the embodiment of the present disclosure” is also simply referred to as a “zoom lens” in order to avoid redundant description.

It is preferable that the zoom lens satisfies Conditional Expression (1). Here, it is assumed that a focal length of the whole system in a state where the infinite distance object is in focus at the telephoto end is ft. It is assumed that a focal length of the whole system in a state where the infinite distance object is in focus at the wide-angle end is fw. It is assumed that an amount of displacement of a lens group, which has a maximum amount of displacement during zooming from the wide-angle end to the telephoto end, among lens groups that move during zooming, is Movmax. That is, a lens group, of which an amount of displacement during zooming from the wide-angle end to the telephoto end is maximum, among the lens groups that move during zooming is referred to as a maximum displacement lens group. In such a case, Movmax is a distance on the optical axis between a position of the maximum displacement lens group at the wide-angle end and a position of the maximum displacement lens group at the telephoto end. In the example of FIG. 1, the maximum displacement lens group is the second subsequent lens group GR2. For example, FIG. 2 shows the amount of displacement Movmax. The unit of Movmax is millimeter (mm). By not allowing the corresponding value of Conditional Expression (1) to be equal to or less than the lower limit value thereof, it is easy to make a small size configuration while achieving a high zoom ratio.

$$0.4 < ( ft / fw ) / Movmax \qquad ( 1 )$$

In order to obtain more favorable characteristics, it is more preferable that the zoom lens satisfies Conditional Expression (1-1). Further, it is preferable that the zoom lens satisfies Conditional Expression (1-2). By not allowing the corresponding value of Conditional Expression (1-2) to be equal to or greater than the upper limit value thereof, Movmax is prevented from becoming excessively small. Therefore, it is easy to perform accurate zoom control. In order to obtain more favorable characteristics, it is more preferable that the zoom lens satisfies Conditional Expression (1-3), it is yet more preferable that the zoom lens satisfies Conditional Expression (1-4), and it is most preferable that the zoom lens satisfies Conditional Expression (1-5).

$$0.8 < ( ft / fw ) / Movmax \qquad ( 1 - 1 )$$

$$0.55 < ( ft / fw ) / Movmax < 10 \qquad ( 1 - 2 )$$

$$0.7 < ( ft / fw ) / Movmax < 5 \qquad ( 1 - 3 )$$

$$0.8 < ( ft / fw ) / Movmax < 4 \qquad ( 1 - 4 )$$

$$1 < ( ft / fw ) / Movmax < 3 \qquad ( 1 - 5 )$$

It is preferable that the zoom lens satisfies Conditional Expression (2). Here, it is assumed that a sum of a distance on the optical axis from the lens surface closest to the object side in the front group GF to the lens surface closest to the image side in the rear group GR in a state where the infinite distance object is in focus, and a back focal length of the whole system in terms of an air-equivalent distance is TL. It is assumed that a maximum image height is Y. For example, FIG. 2 shows the maximum image height Y. It should be noted that TL is the total length of the lens system. By not allowing the corresponding value of Conditional Expression (2) to be equal to or greater than the upper limit value thereof, it is easy to achieve reduction in size, and the maximum image height Y is prevented from becoming excessively small. Therefore, it is easy to achieve an increase in resolution.

$$TL / 2 Y < 80 \qquad ( 2 )$$

In order to obtain more favorable characteristics, it is more preferable that the zoom lens satisfies Conditional Expression (2-1). By not allowing the corresponding value of Conditional Expression (2-1) to be equal to or less than the lower limit value thereof, the TL is prevented from becoming excessively small. Therefore, it is easy to increase the zoom ratio thereof. In order to obtain more favorable characteristics, it is more preferable that the zoom lens satisfies Conditional Expression (2-2), it is yet more preferable that the zoom lens satisfies Conditional Expression (2-3), and it is most preferable that the zoom lens satisfies Conditional Expression (2-4).

$$30 < TL / 2 Y < 78 \qquad ( 2 - 1 )$$

$$40 < TL / 2 Y < 75 \qquad ( 2 - 2 )$$

$$45 < TL / 2 Y < 70 \qquad ( 2 - 3 )$$

$$55 < TL / 2 Y < 68 \qquad ( 2 - 4 )$$

It is preferable that the zoom lens satisfies Conditional Expression (3). By not allowing the corresponding value of Conditional Expression (3) to be equal to or less than the lower limit value thereof, it is possible to suppress an increase in TL. Therefore, it is easy to achieve reduction in size.

$$2 < ft / TL \qquad ( 3 )$$

In order to obtain more favorable characteristics, it is more preferable that the zoom lens satisfies Conditional Expression (3-1). By not allowing the corresponding value of Conditional Expression (3-1) to be equal to or greater than the upper limit value thereof, the TL is prevented from becoming excessively small. Therefore, it is easy to suppress an increase in sensitivity to manufacturing errors. In order to obtain more favorable characteristics, it is more preferable that the zoom lens satisfies Conditional Expression (3-2), it is yet more preferable that the zoom lens satisfies Conditional Expression (3-3), and it is most preferable that the zoom lens satisfies Conditional Expression (3-4).

$$2.2 < ft / TL < 5 \qquad ( 3 - 1 )$$

$$2.4 < ft / TL < 4.5 \qquad ( 3 - 2 )$$

$$2.5 < ft / TL < 4 \qquad ( 3 - 3 )$$

$$2.8 < ft / TL < 3. 5 \qquad ( 3 - 4 )$$

It is preferable that the zoom lens satisfies Conditional Expression (4). Here, it is assumed that a back focal length of the whole system in terms of the air-equivalent distance is Bf. By not allowing the value corresponding to Conditional Expression (4) to be equal to or less than the lower limit value thereof, there is an advantage in achieving reduction in size and improvement in telephoto effect.

$$10 < ft / Bf \qquad ( 4 )$$

In order to obtain more favorable characteristics, it is more preferable that the zoom lens satisfies Conditional Expression (4-1). By not allowing the corresponding value of Conditional Expression (4-1) to be equal to or greater than the upper limit value thereof, the back focal length is prevented from becoming excessively small. Therefore, it is easy to dispose an imaging element or the like that images the image formed by the zoom lens. In order to obtain more favorable characteristics, it is more preferable that the zoom lens satisfies Conditional Expression (4-2), and it is yet more preferable that the zoom lens satisfies Conditional Expression (4-3).

$$30 < ft / Bf < 300 \qquad ( 4 - 1 )$$

$$40 < ft / Bf < 200 \qquad ( 4 - 2 )$$

$$50 < ft / Bf < 150 \qquad ( 4 - 3 )$$

It is preferable that the zoom lens satisfies Conditional Expression (5). By not allowing the corresponding value of Conditional Expression (5) to be equal to or less than the lower limit value thereof, the maximum image height Y is prevented from becoming excessively large. Thus, there is an advantage in achieving reduction in size and an advantage in achieving improvement in telephoto effect.

$$30 < ft / 2 Y \qquad ( 5 )$$

In order to obtain more favorable characteristics, it is more preferable that the zoom lens satisfies Conditional Expression (5-1). By not allowing the corresponding value of Conditional Expression (5-1) to be equal to or greater than the upper limit value thereof, it is easy to increase the size of the imaging element that images the image formed by the zoom lens. Thus, there is an advantage in achieving an increase in resolution. In order to obtain more favorable characteristics, it is more preferable that the zoom lens satisfies Conditional Expression (5-2), and it is yet more preferable that the zoom lens satisfies Conditional Expression (5-3).

$$50 < ft / 2 Y < 300 \qquad ( 5 - 1 )$$

$$70 < ft / 2 Y < 200 \qquad ( 5 - 2 )$$

$$80 < ft / 2 Y < 150 \qquad ( 5 - 3 )$$

It is preferable that the zoom lens satisfies Conditional Expression (6). Here, it is assumed that a focal length of the lens group closest to the object side in the front group GF is fF1. By not allowing the corresponding value of Conditional Expression (6) to be equal to or less than the lower limit value thereof, it is easy to increase the refractive power of the lens group closest to the object side in the front group GF. Therefore, there is an advantage in achieving reduction in size and improvement in telephoto effect.

$$0.5 < ft / fF 1 \qquad ( 6 )$$

In order to obtain more favorable characteristics, it is more preferable that the zoom lens satisfies Conditional Expression (6-1). By not allowing the corresponding value of Conditional Expression (6-1) to be equal to or greater than the upper limit value thereof, the refractive power of the lens group closest to the object side in the front group GF is prevented from becoming excessively strong. Therefore, it is easy to suppress an increase in sensitivity to manufacturing errors. In order to obtain more favorable characteristics, it is more preferable that the zoom lens satisfies Conditional Expression (6-2), and it is yet more preferable that the zoom lens satisfies Conditional Expression (6-3).

$$1 < ft / fF 1 < 16 \qquad ( 6 - 1 )$$

$$2 < ft / fF 1 < 13 \qquad ( 6 - 2 )$$

$$3.5 < ft / fF 1 < 10 \qquad ( 6 - 3 )$$

It is preferable that the zoom lens satisfies Conditional Expression (7). Here, it is assumed that a focal length of the lens group closest to the object side in the intermediate group GM is fM1. By not allowing the corresponding value of Conditional Expression (7) to be equal to or less than the lower limit value thereof, it is easy to increase the refractive power of the lens group closest to the object side in the intermediate group GM. Therefore, there is an advantage in achieving reduction in size and improvement in telephoto effect.

$$5 < \vert ft / fM 1 \vert \qquad ( 7 )$$

In order to obtain more favorable characteristics, it is more preferable that the zoom lens satisfies Conditional Expression (7-1). By not allowing the corresponding value of Conditional Expression (7-1) to be equal to or greater than the upper limit value thereof, the refractive power of the lens group closest to the object side in the intermediate group GM is prevented from becoming excessively strong. Therefore, it is easy to suppress an increase in sensitivity to manufacturing errors. In order to obtain more favorable characteristics, it is more preferable that the zoom lens satisfies Conditional Expression (7-2), it is yet more preferable that the zoom lens satisfies Conditional Expression (7-3), and it is most preferable that the zoom lens satisfies Conditional Expression (7-4).

$$10 < \vert ft / fM 1 \vert < 90 \qquad ( 7 - 1 )$$

$$20 < \vert ft / fM 1 \vert < 75 \qquad ( 7 - 2 )$$

$$30 < \vert ft / fM 1 \vert < 60 \qquad ( 7 - 3 )$$

$$33 < \vert ft / fM 1 \vert < 55 \qquad ( 7 - 4 )$$

It is preferable that the zoom lens satisfies Conditional Expression (8). Here, it is assumed that a focal length of the lens group closest to the object side in the rear group GR is fR1. In the zoom lens of the present disclosure, since the lens group closest to the object side in the rear group GR has a positive refractive power, the lower limit of Conditional Expression (8) is represented by “0<”. By not allowing the corresponding value of Conditional Expression (8) to be equal to or greater than the upper limit value thereof, the refractive power of the lens group closest to the object side in the rear group GR is prevented from becoming excessively strong. Therefore, it is easy to suppress an increase in sensitivity to manufacturing errors. Thereby, it is easy to maintain favorable manufacturability. Thus, there is an advantage in achieving the zoom lens of the present disclosure.

$$0 < ft / fR 1 < 100 \qquad ( 8 )$$

In order to obtain more favorable characteristics, it is more preferable that the zoom lens satisfies Conditional Expression (8-1). By not allowing the corresponding value of Conditional Expression (8-1) to be equal to or less than the lower limit value thereof, it is easy to increase the refractive power of the lens group closest to the object side in the rear group GR. Thus, there is an advantage in achieving reduction in size. In order to obtain more favorable characteristics, it is more preferable that the zoom lens satisfies Conditional Expression (8-2), it is yet more preferable that the zoom lens satisfies Conditional Expression (8-3), and it is most preferable that the zoom lens satisfies Conditional Expression (8-4).

$$1 < ft / fR 1 < 70 \qquad ( 8 - 1 )$$

$$3 < ft / fR 1 < 50 \qquad ( 8 - 2 )$$

$$5 < ft / fR 1 < 45 \qquad ( 8 - 3 )$$

$$7 < ft / fR 1 < 40 \qquad ( 8 - 4 )$$

It is preferable that the zoom lens satisfies Conditional Expression (9). Here, it is assumed that a focal length of the lens group closest to the image side in the rear group GR is fRe. By not allowing the corresponding value of Conditional Expression (9) to be equal to or less than the lower limit value thereof, the negative refractive power of the lens group closest to the image side in the rear group GR is prevented from becoming excessively strong. Therefore, it is easy to suppress an increase in sensitivity to manufacturing errors. By not allowing the corresponding value of Conditional Expression (9) to be equal to or greater than the upper limit value thereof, the positive refractive power of the lens group closest to the image side in the rear group GR is prevented from becoming excessively strong. Therefore, it is easy to suppress an increase in sensitivity to manufacturing errors. By satisfying Conditional Expression (9), it is easy to maintain favorable manufacturability. Thus, there is an advantage in realizing the zoom lens of the present disclosure.

$$- 1 \; 00 < ft / fRe < 200 \qquad ( 9 )$$

According to Conditional Expression (9), it is preferable that the zoom lens satisfies Conditional Expression (9-1) in a case where the lens group closest to the image side in the rear group GR has a positive refractive power. In order to obtain more favorable characteristics, it is more preferable that the zoom lens satisfies Conditional Expression (9-2). By not allowing the corresponding value of Conditional Expression (9-2) to be equal to or less than the lower limit value thereof, it is easy to increase the refractive power of the lens group closest to the image side in the rear group GR. Thus, there is an advantage in achieving reduction in size. In order to obtain more favorable characteristics, it is more preferable that the zoom lens satisfies Conditional Expression (9-3), it is yet more preferable that the zoom lens satisfies Conditional Expression (9-4), and it is most preferable that the zoom lens satisfies Conditional Expression (9-5).

$$0 < ft / fRe < 200 \qquad ( 9 - 1 )$$

$$10 < ft / fRe < 100 \qquad ( 9 - 2 )$$

$$20 < ft / fRe < 80 \qquad ( 9 - 3 )$$

$$25 < ft / fRe < 60 \qquad ( 9 - 4 )$$

$$30 < ft / fRe < 50 \qquad ( 9 - 5 )$$

Further, according to Conditional Expression (9), in a case where the lens group closest to the image side in the rear group GR has a negative refractive power, it is preferable that the zoom lens satisfies Conditional Expression (9-6). In order to obtain more favorable characteristics, it is more preferable that the zoom lens satisfies Conditional Expression (9-7). By not allowing the value corresponding to Conditional Expression (9-7) to be equal to or greater than the upper limit value thereof, it is easy to increase the refractive power of the lens group closest to the image side in the rear group GR. Thus, there is an advantage in ensuring the back focal length thereof. In order to obtain more favorable characteristics, it is more preferable that the zoom lens satisfies Conditional Expression (9-8), it is yet more preferable that the zoom lens satisfies Conditional Expression (9-9), and it is most preferable that the zoom lens satisfies Conditional Expression (9-10).

$$- 1 \; 00 < ft / fRe < 0 \qquad ( 9 - 6 )$$

$$- 50 < ft / fRe < - 0.5 \qquad ( 9 - 7 )$$

$$- 30 < ft / fRe < - 1 \qquad ( 9 - 8 )$$

$$- 20 < ft / fRe < - 1.5 \qquad ( 9 - 9 )$$

$$- 10 < ft / fRe < - 2 \qquad ( 9 - 10 )$$

In a configuration in which the zoom lens includes the focusing group, it is preferable that the zoom lens satisfies Conditional Expression (10). Here, it is assumed that a lateral magnification of the focusing group in a state where the infinite distance object is in focus at the telephoto end is foc. It is assumed that a combined lateral magnification of all lenses closer to the image side than the focusing group in a state where the infinite distance object is in focus at the telephoto end is βfocR. In a case where there is no lens closer to the image side than the focusing group, βfocR=1. By not allowing the corresponding value of Conditional Expression (10) to be equal to or greater than the upper limit value thereof, it is possible to reduce the amount of movement of the image per unit amount of movement of the focusing group, and thus it is easy to perform accurate focusing.

$$\vert ( 1 - β {foc}^{2} ) \times β {focR}^{2} \vert < 50 \qquad ( 10 )$$

In order to obtain more favorable characteristics, it is more preferable that the zoom lens satisfies Conditional Expression (10-1), it is yet more preferable that the zoom lens satisfies Conditional Expression (10-2), it is even more preferable that the zoom lens satisfies Conditional Expression (10-3), and it is most preferable that the zoom lens satisfies Conditional Expression (10-4).

$$0 < \vert ( 1 - β {foc}^{2} ) \times β {focR}^{2} \vert < 20 \qquad ( 10 - 1 )$$

$$0 < \vert ( 1 - β {foc}^{2} ) \times β {focR}^{2} \vert < 10 \qquad ( 10 - 2 )$$

$$0 < \vert ( 1 - β {foc}^{2} ) \times β {focR}^{2} \vert < 8 \qquad ( 10 - 3 )$$

$$0 < \vert ( 1 - β {foc}^{2} ) \times β {focR}^{2} \vert < 6 \qquad ( 10 - 4 )$$

It is preferable that the zoom lens satisfies Conditional Expression (11). Here, the lens group closest to the object side in the intermediate group GM is referred to as a first intermediate lens group. It is assumed that a lateral magnification of the first intermediate lens group in a state where the infinite distance object is in focus at the telephoto end is βM1. It is assumed that a combined lateral magnification of all lenses closer to the image side than the first intermediate lens group in a state where the infinite distance object is in focus at the telephoto end is βM1R. By not allowing the corresponding value of Conditional Expression (11) to be equal to or less than the lower limit value thereof, there is an advantage in achieving reduction in size. By not allowing the corresponding value of Conditional Expression (11) to be equal to or greater than the upper limit value thereof, the amount of movement of the image per unit amount of movement of the first intermediate lens group is prevented from becoming excessively large. Therefore, it is easy to prevent the manufacturing from being more difficult.

$$10 < \vert ( 1 - β M {1}^{2} ) \times β M 1 {R}^{2} \vert < 100 \qquad ( 11 )$$

It should be noted that in a case where the intermediate group GM consists of only one lens group, the intermediate group GM is the first intermediate lens group.

In order to obtain more favorable characteristics, it is more preferable that the zoom lens satisfies Conditional Expression (11-1), it is yet more preferable that the zoom lens satisfies Conditional Expression (11-2), and it is most preferable that the zoom lens satisfies Conditional Expression (11-3).

$$20 < \vert ( 1 - β M {1}^{2} ) \times β M 1 {R}^{2} \vert < 90 \qquad ( 11 - 1 )$$

$$30 < \vert ( 1 - β M {1}^{2} ) \times β M 1 {R}^{2} \vert < 80 \qquad ( 11 - 2 )$$

$$40 < \vert ( 1 - β M {1}^{2} ) \times β M 1 {R}^{2} \vert < 70 \qquad ( 11 - 3 )$$

The example shown in FIG. 1 is an example, and various modifications can be made without departing from the scope of the technique according to the embodiment of the present disclosure. For example, the number of lens groups included in each of the front group GF, the intermediate group GM, and the rear group GR may be different from the number thereof in the example of FIG. 1. Further, the number of lenses, which are included in each lens group, the number of lenses that are included in the focusing group, and the number of lenses, which are included in the vibration-proof group, may be different from the numbers in the example of FIG. 1. The lens corresponding to the focusing group, the lens corresponding to the vibration-proof group, the position of the aperture stop St, and the lens group, which moves during zooming, may be configured to be different from those in the example shown in FIG. 1.

Further, at any position of the zoom lens, at least one of an infrared cut filter, a visible light cut filter, a filter that transmits only light having a specific wavelength, a neutral density (ND) filter, a polarizing filter, or the like may be disposed.

The above-mentioned preferred configurations and available configurations may be optionally combined without contradiction, and it is preferable to selectively adopt the configurations in accordance with necessary specification.

For example, according to a preferred embodiment of the zoom lens of the present disclosure, the zoom lens consists of, in order from the object side to the image side, a front group GF, an intermediate group GM, and a rear group GR. The front group GF consists of one lens group or two or fewer lens groups that have positive refractive powers. The lens group closest to the object side in the front group GF remains stationary with respect to the image plane Sim during zooming. The intermediate group GM consists of one lens group or two or fewer lens groups that have negative refractive powers. The rear group GR consists of a plurality of lens groups. The lens group closest to the object side in the rear group GR has a positive refractive power. The lens group closest to the image side in the rear group GR remains stationary with respect to the image plane Sim during zooming. All spacings between adjacent lens groups change during zooming. Then, Conditional Expression (1) is satisfied.

Next, examples of the zoom lens according to the embodiment of the present disclosure will be described, with reference to the drawings. It should be noted that the reference numerals attached to the lenses and the lens groups in the cross-sectional views of each example are used independently for each example in order to avoid complication of description and drawings caused by an increase in number of digits of the reference numerals. Therefore, even in a case where common reference numerals are attached in the drawings of different examples, components do not necessarily have a common configuration.

### Example 1

FIG. 1 shows a configuration and movement loci of a zoom lens of Example 1, and an illustration method and a configuration thereof are as described above. Therefore, some description is not repeated herein. The zoom lens of Example 1 consists of a front group GF, an intermediate group GM, and a rear group GR, in order from the object side to the image side. The front group GF consists of one lens group that has a positive refractive power. The intermediate group GM consists of one lens group that has a negative refractive power. The rear group GR consists of, in order from the object side to the image side, three lens groups including a first subsequent lens group GR1 that has a positive refractive power, a second subsequent lens group GR2 that has a negative refractive power, and a third subsequent lens group GR3 that has a positive refractive power. During zooming from the wide-angle end to the telephoto end, the front group GF and the third subsequent lens group GR3 remain stationary with respect to the image plane Sim, and the intermediate group GM, the first subsequent lens group GR1, and the second subsequent lens group GR2 move along the optical axis Z by changing the spacings between the adjacent lens groups.

Regarding the zoom lens of Example 1, Table 1 shows basic lens data, Table 2 shows specifications, Table 3 shows variable surface spacings, and Table 4 shows aspherical coefficients thereof.

The table of basic lens data will be described as follows. The Sn column shows surface numbers in a case where the surface closest to the object side is the first surface and the number is increased one by one toward the image side. The R column shows a curvature radius of each surface. The D column shows a surface spacing between each surface and the surface adjacent to the image side on the optical axis. The Nd column indicates a refractive index of each lens at the d-line. The vd column shows the Abbe number of each lens based on the d-line.

The “d-line”, “C-line”, and “F-line” described in the present specification are bright lines, the wavelength of the d-line is 587.56 nanometers (nm), the wavelength of the C-line is 656.27 nanometers (nm), and the wavelength of the F-line is 486.13 nanometers (nm).

In the table of the basic lens data, the sign of the curvature radius of the convex surface facing toward the object side is positive, and the sign of the curvature radius of the convex surface facing toward the image side is negative. Table 1 also shows the aperture stop St and the optical member PP. In a cell of a surface number of a surface corresponding to the aperture stop St, the surface number and a term of (St) are noted. A value at the bottom cell of the D column in the table indicates a spacing between the image plane Sim and the surface closest to the image side in the table. The symbol DD [ ] is used for each variable surface spacing during zooming, and the object side surface number of the spacing is given in [ ] and is noted in the D column.

Table 2 shows the zoom ratio Zr, the focal length f, the back focal length Bf in terms of the air-equivalent distance, the open F number FNo., the maximum total angle of view 2ω, and the maximum image height Y, on the basis of the d-line. The zoom ratio is synonymous with the zoom magnification. [°] in the cells of 2ω indicates that the unit thereof is a degree. In Table 2, columns labeled “Wide” and “Tele” respectively show values in the wide-angle end state and the telephoto end state.

Table 3 shows the variable surface spacing during zooming. In Table 3, columns labeled “Wide” and “Tele” respectively show values in the wide-angle end state and the telephoto end state.

In basic lens data, a reference sign * is attached to surface numbers of aspherical surfaces, and values of the paraxial curvature radius are noted into the column of the curvature radius of the aspherical surface. In Table 4, the row of Sn shows surface numbers of the aspherical surfaces, and the rows of KA and Am show numerical values of the aspherical coefficients for each aspherical surface. It should be noted that m of Am is an integer of 3 or more, and differs depending on the surface. For example, in the eleventh surface of Example 1, m=3, 4, 5, . . . , and 20. The “E±n” (n: an integer) in numerical values of the aspherical coefficients of Table 4 indicates “×10^{±n}”. KA and Am are the aspherical coefficients in the aspherical surface expression represented by the following expression.

$$Zd = C \times {h}^{2} / \{ 1 + {( 1 - KA \times {C}^{2} \times {h}^{2} )}^{1 / 2} \} + Σ Am \times {h}^{m}$$

Here,
Zd is an aspherical surface depth (a length of a perpendicular from a point on an aspherical surface at height h to a plane that is perpendicular to the optical axis Z and that is in contact with the vertex of the aspherical surface),
h is a height (a distance from the optical axis Z to the lens surface),
C is an inverse of the paraxial curvature radius,
KA and Am are aspherical coefficients, and
Σ in the aspherical surface expression means the sum with respect to m.

In the data of each table, degrees are used as a unit of an angle, and millimeters are used as a unit of a length, but appropriate different units may be used since the optical system can be used even in a case where the system is enlarged or reduced in proportion. Each of the following tables shows numerical values rounded off to predetermined decimal places.

TABLE 1
Example 1

| Sn | R | D | Nd | νd |
|---|---|---|---|---|
| 1 | 147.6534 | 16.6706 | 1.49700 | 81.54 |
| 2 | −414.4192 | 0.0594 | | |
| 3 | 113.2390 | 19.5723 | 1.43875 | 94.66 |
| 4 | −251.8451 | 0.3546 | | |
| 5 | −244.8250 | 3.0555 | 1.81600 | 46.62 |
| 6 | 122.1038 | 0.3566 | | |
| 7 | 87.5317 | 14.9714 | 1.49700 | 81.54 |
| 8 | 2484.7195 | 0.0776 | | |
| 9 | 71.9900 | 11.3958 | 1.49700 | 81.54 |
| 10 | 162.7856 | DD[10] | | |
| *11 | 206.5353 | 1.8627 | 1.96300 | 24.11 |
| *12 | 31.6144 | 6.7039 | | |
| 13 | −154.7149 | 7.0548 | 1.95906 | 17.47 |
| 14 | −29.9827 | 1.6437 | 1.72916 | 54.09 |
| 15 | 40.4244 | DD[15] | | |
| 16 | 41.1516 | 10.6812 | 1.80100 | 34.97 |
| 17 | −30.3155 | 1.7687 | 2.00100 | 29.14 |
| 18 | 342.1222 | DD[18] | | |
| 19 | −223.0172 | 1.4848 | 1.60300 | 65.44 |
| 20 | 16.2896 | 3.0929 | 1.68893 | 31.07 |
| 21 | 41.2505 | 2.3813 | | |
| 22 | −30.5188 | 1.3615 | 1.55200 | 70.70 |
| 23 | 263.5177 | DD[23] | | |
| 24(St) | ∞ | 0.2500 | | |
| 25 | 47.4779 | 4.0926 | 1.49700 | 81.54 |
| 26 | −84.5197 | 2.0115 | | |
| 27 | 455.1103 | 2.1943 | 1.49700 | 81.54 |
| 28 | −95.0230 | 0.0318 | | |
| 29 | 112.8905 | 1.8035 | 1.65160 | 58.54 |
| 30 | 2456.8899 | 0.0345 | | |
| 31 | 47.6626 | 5.2336 | 1.49700 | 81.54 |
| 32 | −43.3266 | 0.9999 | 1.95375 | 32.32 |
| 33 | 1442.5172 | 3.8123 | | |
| 34 | −33.5272 | 4.9914 | 1.92286 | 18.90 |
| 35 | −34.4209 | 34.2500 | | |
| *36 | 31.4149 | 3.0041 | 1.55332 | 71.68 |
| *37 | −125.8833 | 1.1246 | | |
| 38 | −28.3923 | 1.0000 | 1.64850 | 53.02 |
| 39 | 16.2384 | 8.5114 | 1.51633 | 64.14 |
| 40 | −21.7659 | 1.0000 | | |
| 41 | −23.5453 | 2.1302 | 1.43875 | 94.66 |
| 42 | −11.3338 | 1.0449 | 1.95375 | 32.32 |
| 43 | −59.3529 | 0.4118 | | |
| 44 | −38.7859 | 3.4795 | 1.84666 | 23.78 |
| 45 | −15.0799 | 7.0000 | | |
| 46 | ∞ | 1.0000 | 1.51680 | 64.20 |
| 47 | ∞ | 0.4400 | | |

TABLE 2
Example 1

| | Wide | Tele |
|---|---|---|
| Zr | 1.0 | 57.0 |
| f | 14.51 | 826.82 |
| Bf | 8.10 | 8.10 |
| FNo. | 2.81 | 7.54 |
| 2ω[°] | 33.0 | 0.6 |
| Y | 4.65 | |

TABLE 3
Example 1

| | Wide | Tele |
|---|---|---|
| DD[10] | 1.83 | 47.53 |
| DD[15] | 15.91 | 0.52 |
| DD[18] | 45.42 | 62.54 |
| DD[23] | 48.10 | 0.68 |

TABLE 4
Example 1

| Sn | 11 | 12 | 36 | 37 |
|---|---|---|---|---|
| KA | −3.1881964E+00 | 9.5945908E−01 | 6.8174766E−01 | −5.7736037E−01 |
| A3 | 2.9914579E−05 | 2.9755000E−05 | −3.9293723E−05 | −2.8048129E−05 |
| A4 | 1.5636982E−06 | 2.8380368E−06 | 4.3720309E−06 | 5.4529912E−06 |
| A5 | 7.9794438E−08 | 5.3460576E−08 | −3.6352797E−08 | 2.6248745E−07 |
| A6 | −3.4127702E−09 | 3.8093423E−09 | 2.2565203E−08 | −7.8553248E−09 |
| A7 | −1.1601342E−10 | −9.9726877E−11 | 3.1856377E−09 | 4.6372196E−10 |
| A8 | 1.5135284E−12 | 1.1801621E−12 | −6.3482730E−11 | −1.4698462E−10 |
| A9 | −1.1130423E−13 | −3.2398722E−13 | −6.5412637E−12 | −1.2967333E−11 |
| A10 | 4.5339654E−15 | 4.5700449E−15 | −1.8528531E−12 | 7.1319926E−13 |
| A11 | 4.3391680E−17 | −1.2367743E−16 | −2.1066161E−13 | 1.0126831E−13 |
| A12 | 2.5225840E−17 | 6.5069356E−17 | −2.7634124E−16 | −1.1632251E−14 |
| A13 | 2.0588366E−18 | −2.8189867E−18 | 6.1575112E−16 | −4.3208640E−16 |
| A14 | −1.4169173E−19 | 5.5250116E−19 | −4.3523865E−18 | −2.9328814E−16 |
| A15 | 1.7302364E−21 | 1.3929424E−20 | 2.1671742E−17 | −2.6035164E−17 |
| A16 | −3.5984515E−23 | −5.4989548E−22 | −3.3421575E−18 | −5.9228571E−19 |
| A17 | −1.1992709E−23 | −1.5336957E−22 | −3.0183171E−19 | −3.7843290E−20 |
| A18 | 4.7525995E−25 | 7.2259726E−26 | −1.1840670E−20 | −3.3198439E−20 |
| A19 | −8.5662921E−27 | −1.1054246E−25 | 1.4265769E−21 | −2.5504526E−21 |
| A20 | 2.6258322E−28 | 1.4778264E−26 | 7.3011972E−23 | 7.1928279E−22 |

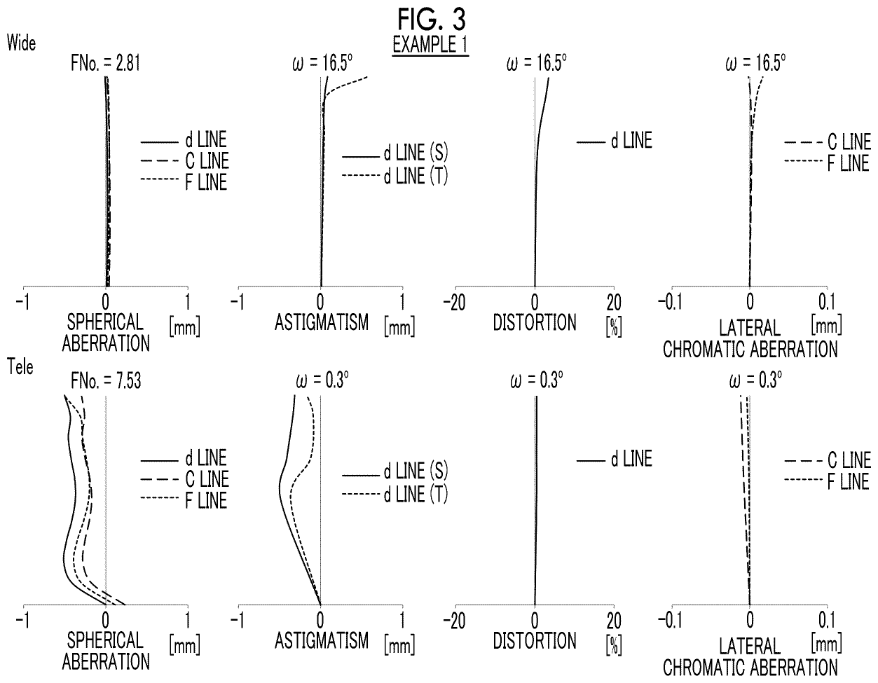

FIG. 3 is a diagram showing aberrations of the zoom lens of Example 1 in a state where the infinite distance object is in focus. FIG. 3 shows spherical aberration, astigmatism, distortion, and lateral chromatic aberration, in order from the left side. In FIG. 3, the upper part labeled “Wide” shows aberrations in the wide-angle end state, and the lower part labeled “Tele” shows aberrations in the telephoto end state. In the spherical aberration diagram, aberrations at the d-line, the C-line, and the F-line are indicated by the solid line, the long broken line, and the short broken line, respectively. In the astigmatism diagram, aberration in the sagittal direction at the d-line is indicated by the solid line, and aberration in the tangential direction at the d-line is indicated by the short broken line. In the distortion diagram, aberration at the d-line is indicated by a solid line. In the lateral chromatic aberration diagram, aberrations at the C-line, and the F-line are respectively indicated by the long broken line, and the short broken line. In the spherical aberration diagram, the value of the open F number is shown after FNo.=. In other aberration diagrams, the value of the maximum half angle of view is shown after ω=.

Symbols, meanings, description methods, and illustration methods of the respective data pieces according to Example 1 are basically similar to those in the following examples unless otherwise specified. Therefore, in the following description, repeated description will not be given.

### Example 2

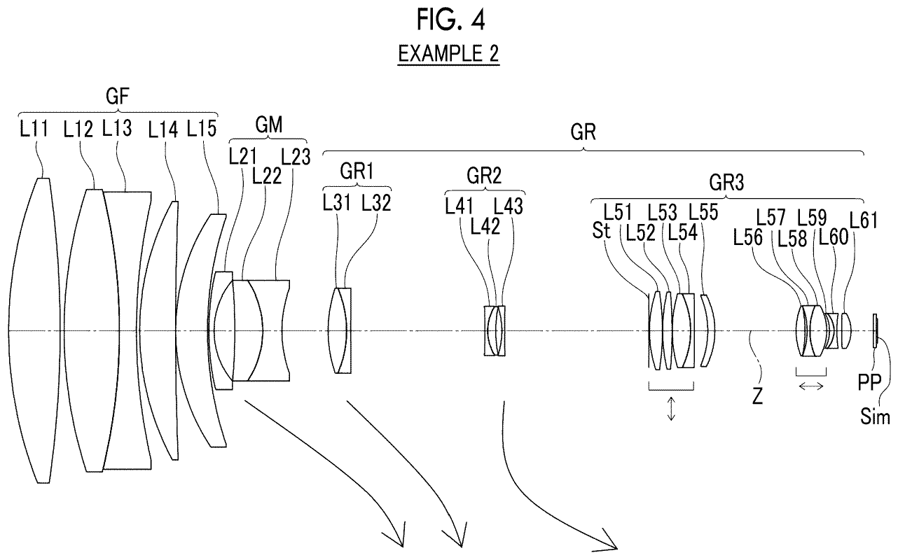

FIG. 4 shows a configuration and movement loci of the zoom lens of Example 2. The zoom lens of Example 2 consists of a front group GF, an intermediate group GM, and a rear group GR, in order from the object side to the image side. The front group GF consists of one lens group that has a positive refractive power. The intermediate group GM consists of one lens group that has a negative refractive power. The rear group GR consists of, in order from the object side to the image side, three lens groups including a first subsequent lens group GR1 that has a positive refractive power, a second subsequent lens group GR2 that has a negative refractive power, and a third subsequent lens group GR3 that has a positive refractive power. During zooming from the wide-angle end to the telephoto end, the front group GF and the third subsequent lens group GR3 remain stationary with respect to the image plane Sim, and the intermediate group GM, the first subsequent lens group GR1, and the second subsequent lens group GR2 move along the optical axis Z by changing the spacings between the adjacent lens groups.

The front group GF consists of five lenses L11 to L15, in order from the object side to the image side. The intermediate group GM consists of three lenses L21 to L23, in order from the object side to the image side. The first subsequent lens group GR1 consists of two lenses L31 and L32, in order from the object side to the image side. The second subsequent lens group GR2 consists of three lenses L41 to L43, in order from the object side to the image side. The third subsequent lens group GR3 consists of an aperture stop St and eleven lenses L51 to L61, in order from the object side to the image side. The focusing group consists of three lenses L56 to L58. The vibration-proof group consists of four lenses L51 to L54.

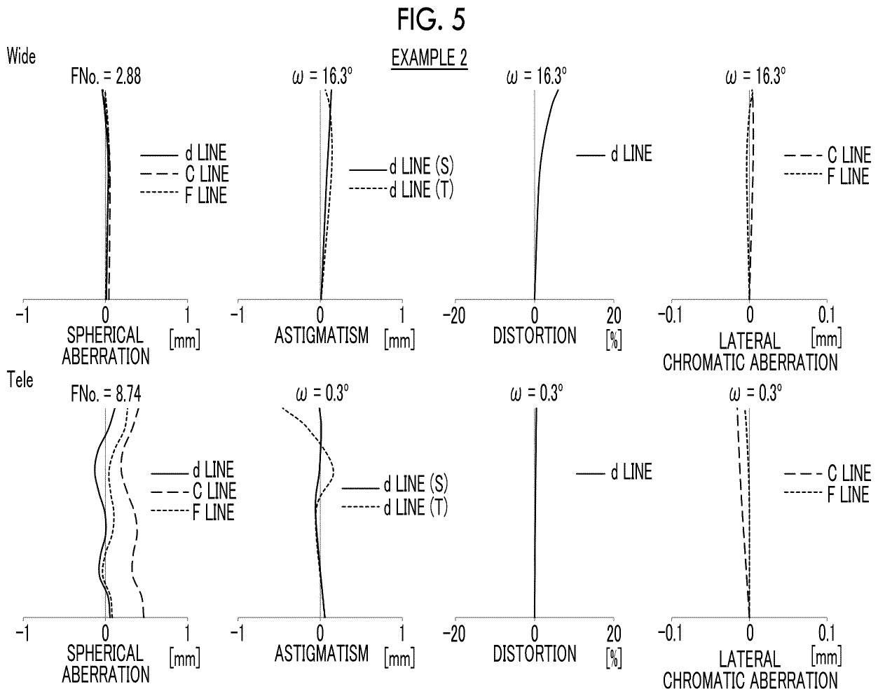

Regarding the zoom lens of Example 2, Table 5 shows basic lens data, Table 6 shows specifications, Table 7 shows variable surface spacings, and Table 8 shows aspherical coefficients thereof. FIG. 5 shows aberration diagrams thereof.

TABLE 5
Example 2

| Sn | R | D | Nd | νd |
|---|---|---|---|---|
| 1 | 151.5768 | 18.4588 | 1.49700 | 81.54 |
| 2 | −387.8515 | 1.4209 | | |
| 3 | 165.6241 | 19.8244 | 1.43875 | 94.66 |
| 4 | −216.0083 | 6.1019 | 1.83481 | 42.74 |
| 5 | 211.0380 | 1.1655 | | |
| *6 | 98.6566 | 12.8704 | 1.49700 | 81.54 |
| *7 | 1171.4109 | 0.0250 | | |
| 8 | 76.2442 | 11.4272 | 1.49700 | 81.54 |
| 9 | 129.4214 | DD[9] | | |
| *10 | 101.0475 | 1.8543 | 1.95150 | 29.83 |
| *11 | 29.1368 | 7.4203 | | |
| 12 | −209.8949 | 10.0320 | 1.95906 | 17.47 |
| 13 | −32.7224 | 6.8605 | 1.78800 | 47.37 |
| 14 | 44.6063 | DD[14] | | |
| 15 | 46.6766 | 6.6531 | 1.76200 | 40.10 |
| 16 | −38.8252 | 1.5045 | 2.00100 | 29.14 |
| 17 | 1527.4475 | DD[17] | | |
| 18 | −280.1552 | 1.0020 | 1.62041 | 60.29 |
| 19 | 16.7919 | 2.9119 | 1.69895 | 30.13 |
| 20 | 45.2184 | 2.1711 | | |
| 21 | −28.6486 | 1.0002 | 1.55200 | 70.70 |
| 22 | 377.0683 | DD[22] | | |
| 23(St) | ∞ | 0.2500 | | |
| *24 | 43.8709 | 4.6716 | 1.49700 | 81.54 |
| *25 | −91.8232 | 0.0250 | | |
| 26 | 60.4512 | 3.4245 | 1.49700 | 81.54 |
| 27 | −171.9570 | 0.0756 | | |
| 28 | 47.8309 | 6.5758 | 1.49700 | 81.54 |
| 29 | −30.6829 | 1.3351 | 1.95375 | 32.32 |
| 30 | −1043.1686 | 4.8025 | | |
| 31 | −32.3850 | 2.5432 | 1.95906 | 17.47 |
| 32 | −28.5503 | 29.1000 | | |
| *33 | 23.5386 | 3.1879 | 1.49710 | 81.56 |
| *34 | −46.2792 | 0.7806 | | |
| 35 | −25.5458 | 1.0002 | 1.80400 | 46.53 |
| 36 | 23.0522 | 6.0219 | 1.51742 | 52.43 |
| 37 | −18.6678 | 1.0000 | | |
| 38 | −13.4415 | 1.6124 | 1.43875 | 94.66 |
| 39 | −9.7175 | 1.0000 | 2.00100 | 29.14 |
| 40 | 41.2790 | 1.7398 | | |
| 41 | 109.7541 | 3.3729 | 1.85478 | 24.80 |
| 42 | −12.4236 | 8.0000 | | |
| 43 | ∞ | 1.0000 | 1.51680 | 64.20 |
| 44 | ∞ | 0.4500 | | |

TABLE 6
Example 2

| | Wide | Tele |
|---|---|---|
| Zr | 1.0 | 66.7 |
| f | 14.42 | 961.02 |
| Bf | 9.11 | 9.11 |
| FNo. | 2.88 | 8.76 |
| 2ω[°] | 32.6 | 0.6 |
| Y | 4.65 | |

TABLE 7
Example 2

| | Wide | Tele |
|---|---|---|
| DD[9] | 0.50 | 53.03 |
| DD[14] | 16.55 | 0.51 |
| DD[17] | 47.87 | 62.12 |
| DD[22] | 51.67 | 0.92 |

TABLE 8
Example 2

| Sn | 6 | 7 | 24 | 25 |
|---|---|---|---|---|
| KA | 1.0000000E+00 | 1.0000000E+00 | 9.9999023E−01 | 1.0000022E+00 |
| A3 | −2.3779951E−26 | −5.2696984E−27 | 3.5297301E−22 | 1.4313065E−23 |
| A4 | 1.3337985E−11 | −8.2520682E−15 | −3.7553793E−08 | −5.9215668E−08 |
| A5 | 1.0585045E−12 | −5.1063039E−14 | −1.5553175E−08 | −1.5232015E−08 |
| A6 | −3.4753886E−14 | 1.2548766E−16 | −2.2163133E−09 | 4.0898428E−09 |
| A7 | −1.0663160E−15 | 3.7397438E−17 | 1.3002803E−10 | 4.5067643E−10 |
| A8 | 3.1225812E−17 | −9.4109042E−19 | 5.4383993E−11 | −1.0536804E−10 |
| A9 | −4.2992818E−19 | 1.0401013E−19 | −1.4744795E−12 | −8.0023742E−12 |
| A10 | −7.2104421E−21 | 3.9393861E−21 | −9.7710698E−13 | 1.5920926E−12 |
| A11 | 1.1639872E−21 | −5.2850334E−22 | 1.5442061E−14 | 8.4663703E−14 |
| A12 | −5.8156315E−24 | −9.7997453E−24 | 1.1215736E−14 | −1.5371282E−14 |
| A13 | −2.1312012E−24 | 1.5972859E−24 | −1.0751834E−16 | −5.3896679E−16 |
| A14 | 4.2833212E−26 | 1.1926269E−26 | −7.4877045E−17 | 9.5542976E−17 |
| A15 | 2.5585685E−27 | −2.8422290E−27 | 4.4401724E−19 | 2.0460889E−18 |
| A16 | −6.2962142E−29 | 1.4296126E−30 | 2.8332623E−19 | −3.6827203E−19 |
| A17 | −1.5420243E−30 | 2.7424903E−30 | −9.8186009E−22 | −4.3295433E−21 |
| A18 | 4.3594550E−32 | −1.8774536E−32 | −5.6509591E−22 | 7.9814796E−22 |
| A19 | 3.3083413E−34 | −1.0950452E−33 | 8.9383004E−25 | 3.9881954E−24 |
| A20 | −1.0943260E−35 | 1.3130056E−35 | 4.6142411E−25 | −7.4196887E−25 |

| Sn | 10 | 11 | 33 | 34 |
|---|---|---|---|---|
| KA | −2.6971237E+00 | 9.5891769E−01 | 1.0406211E+00 | −1.8127994E+00 |
| A3 | −5.2514390E−19 | 3.5300423E−19 | −2.7336166E−17 | −2.2664176E−18 |
| A4 | 4.6712621E−06 | 6.1090095E−06 | −1.1764210E−04 | −5.2200016E−05 |
| A5 | −1.7900678E−06 | −2.8506827E−06 | 1.0067989E−04 | 7.4111786E−05 |
| A6 | 3.8815439E−07 | 7.8547518E−07 | −4.2904928E−05 | −4.3236418E−05 |
| A7 | −4.6222300E−08 | −1.2221056E−07 | 4.1739002E−06 | 1.2226788E−05 |
| A8 | 2.9128365E−09 | 1.0289595E−08 | 4.3164849E−06 | −1.2446795E−06 |
| A9 | −7.7260275E−12 | −1.2675028E−10 | −2.0495836E−06 | −2.2572586E−07 |
| A10 | −1.2648915E−11 | −6.3958220E−11 | 3.4377318E−07 | 8.4106163E−08 |
| A11 | 6.8230360E−13 | 5.9378664E−12 | 3.6850034E−09 | −6.9091788E−09 |
| A12 | 7.9560528E−15 | −9.8664092E−14 | −9.7828565E−09 | −1.0005134E−09 |
| A13 | −1.7432271E−15 | −1.7481974E−14 | 1.1437009E−09 | 2.3435829E−10 |
| A14 | 3.1915465E−17 | 1.1731086E−15 | 4.0694128E−11 | −6.0613771E−12 |
| A15 | 1.6689977E−18 | −5.0784838E−18 | −1.7797971E−11 | −2.2905261E−12 |
| A16 | −6.4890168E−20 | −2.0947764E−18 | 8.6340854E−13 | 1.9517066E−13 |
| A17 | −4.3222461E−22 | 7.1397629E−20 | 8.3520849E−14 | 5.8411956E−15 |
| A18 | 4.9573544E−23 | 2.9589586E−22 | −9.3142886E−15 | −1.2439798E−15 |
| A19 | −3.1678075E−25 | −6.1100616E−23 | 5.0829299E−17 | 2.3386308E−17 |
| A20 | −1.6693921E−26 | 1.3148824E−24 | 2.6039247E−17 | 2.2278601E−18 |
| A21 | 2.4914935E−28 | −1.0660925E−26 | −9.0598256E−19 | −8.0814098E−20 |

### Example 3

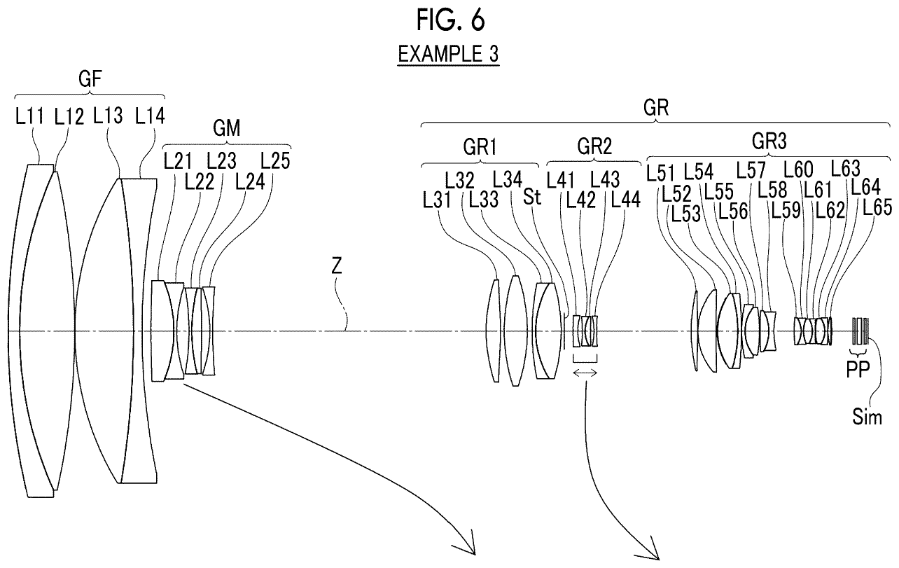

FIG. 6 shows a configuration and movement loci of the zoom lens of Example 3. The zoom lens of Example 3 consists of a front group GF, an intermediate group GM, and a rear group GR, in order from the object side to the image side. The front group GF consists of one lens group that has a positive refractive power. The intermediate group GM consists of one lens group that has a negative refractive power. The rear group GR consists of, in order from the object side to the image side, three lens groups including a first subsequent lens group GR1 that has a positive refractive power, a second subsequent lens group GR2 that has a negative refractive power, and a third subsequent lens group GR3 that has a positive refractive power. During zooming from the wide-angle end to the telephoto end, the front group GF, the first subsequent lens group GR1, and the third subsequent lens group GR3 remain stationary with respect to the image plane Sim, and the intermediate group GM and the second subsequent lens group GR2 move along the optical axis Z by changing the spacings between the adjacent lens groups.

The front group GF consists of four lenses L11 to L14, in order from the object side to the image side. The intermediate group GM consists of five lenses L21 to L25, in order from the object side to the image side. The first subsequent lens group GR1 consists of four lenses L31 to L34 and an aperture stop St, in order from the object side to the image side. The second subsequent lens group GR2 consists of four lenses L41 to L44, in order from the object side to the image side. The third subsequent lens group GR3 consists of 15 lenses L51 to L65, in order from the object side to the image side. The focusing group consists of the second subsequent lens group GR2.

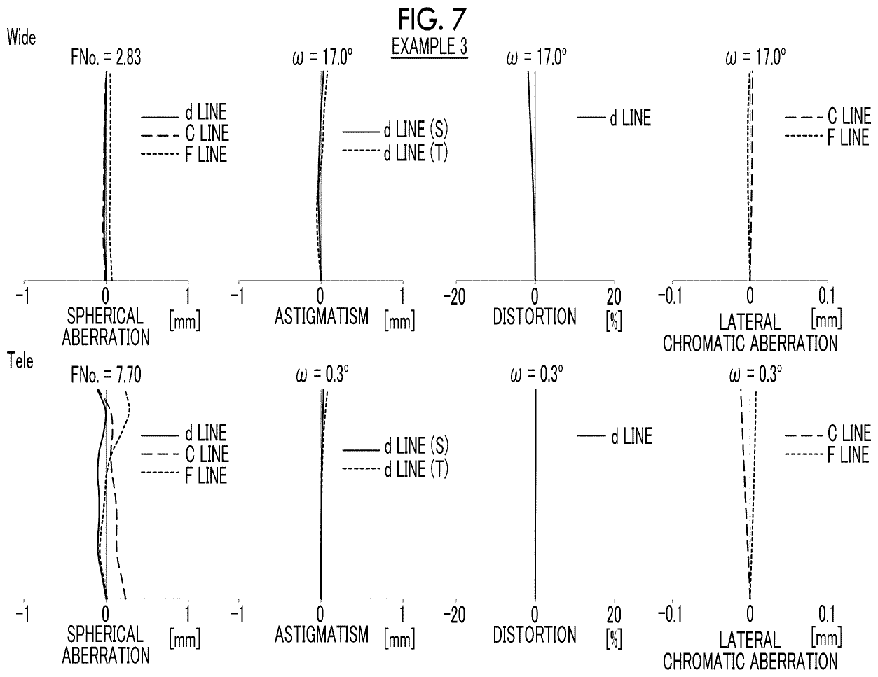

Regarding the zoom lens of Example 3, Tables 9A and 9B show basic lens data, Table 10 shows specification, Table 11 shows variable surface spacings, and Table 12 shows aspherical coefficients thereof. FIG. 7 shows aberration diagrams thereof. It should be noted that Examples 3, 4, 7, and 8 each show the basic lens data divided in two tables in order to avoid an increase in length of one table.

TABLE 9A
Example 3

| Sn | R | D | Nd | νd |
|---|---|---|---|---|
| 1 | 247.0132 | 4.0000 | 1.64769 | 33.84 |
| 2 | 135.9541 | 19.2417 | 1.49700 | 81.61 |
| 3 | −254.8294 | 0.1000 | | |
| 4 | 101.9135 | 20.5187 | 1.49700 | 81.61 |
| 5 | −325.1368 | 3.0000 | 1.66672 | 48.32 |
| 6 | 246.3851 | DD[6] | | |
| 7 | 465.2322 | 8.0000 | 1.84666 | 23.78 |
| 8 | −44.6990 | 1.0100 | 1.67790 | 55.34 |
| 9 | 48.2074 | 4.2724 | | |
| 10 | −84.6935 | 1.0102 | 1.80420 | 46.50 |
| 11 | 59.3825 | 3.3477 | 1.85451 | 25.15 |
| 12 | −1628.2054 | 2.9568 | | |
| 13 | −43.9693 | 1.0002 | 1.80420 | 46.50 |
| 14 | 172.6194 | DD[14] | | |
| *15 | 50.5583 | 5.0000 | 1.51633 | 64.06 |
| *16 | −125.3084 | 1.3411 | | |
| 17 | 61.1190 | 8.0872 | 1.49700 | 81.61 |
| 18 | −59.0873 | 1.6933 | | |
| 19 | 83.7151 | 1.2610 | 1.85451 | 25.15 |
| 20 | 31.6889 | 8.8762 | 1.49700 | 81.61 |
| 21 | −57.0227 | 1.1106 | | |
| 22(St) | ∞ | DD[22] | | |
| 23 | 285.1349 | 1.6494 | 1.74950 | 35.33 |
| 24 | 17.8611 | 1.5696 | | |
| 25 | −62.3904 | 1.0100 | 1.72916 | 54.68 |
| 26 | 10.5309 | 1.8878 | 1.80518 | 25.42 |
| 27 | 149.3643 | 1.1735 | | |
| 28 | −23.5963 | 0.9999 | 1.71700 | 47.93 |
| 29 | 90.8642 | DD[29] | | |

TABLE 9B
Example 3

| Sn | R | D | Nd | νd |
|---|---|---|---|---|
| *30 | 48.7805 | 2.2673 | 1.51633 | 64.06 |
| *31 | −270.3360 | 0.1000 | | |
| 32 | 21.4268 | 6.3809 | 1.49700 | 81.61 |
| 33 | 589.0228 | 0.5318 | | |
| 34 | 22.6441 | 7.0428 | 1.49700 | 81.61 |
| 35 | −45.1099 | 1.2873 | 1.77250 | 49.60 |
| 36 | −133.3459 | 0.1001 | | |
| 37 | 43.6056 | 1.1647 | 1.85026 | 32.27 |
| 38 | 13.5562 | 5.0108 | 1.49700 | 81.61 |
| 39 | 54.9688 | 0.1937 | | |
| 40 | 99.2214 | 3.1141 | 1.49700 | 81.61 |
| 41 | −14.7705 | 1.7783 | 1.80400 | 46.58 |
| 42 | 28.6695 | 7.1137 | | |
| 43 | 64.4441 | 2.4069 | 1.89286 | 20.36 |
| 44 | −8.8639 | 0.8000 | 1.90043 | 37.37 |
| 45 | 10.2165 | 0.1001 | | |
| 46 | 10.7107 | 3.0377 | 1.62004 | 36.26 |
| 47 | −8.9759 | 1.0001 | 1.90043 | 37.37 |
| 48 | 67.6153 | 0.1073 | | |
| 49 | 17.5822 | 3.2369 | 1.58144 | 40.89 |
| 50 | −8.0039 | 1.0000 | 1.88300 | 40.80 |
| 51 | −115.1517 | 0.1002 | | |
| 52 | 17.8446 | 1.1272 | 1.51823 | 58.90 |
| 53 | −56.4855 | 7.7002 | | |
| 54 | ∞ | 0.6000 | 1.51680 | 64.20 |
| 55 | ∞ | 0.8000 | | |
| 56 | ∞ | 1.5500 | 1.51680 | 64.20 |
| 57 | ∞ | 0.8500 | | |
| 58 | ∞ | 0.7000 | 1.51680 | 64.20 |
| 59 | ∞ | 0.7000 | | |

TABLE 10
Example 3

| | Wide | Tele |
|---|---|---|
| Zr | 1.0 | 57.0 |
| f | 14.87 | 847.32 |
| Bf | 11.93 | 11.93 |
| FNo. | 2.83 | 7.70 |
| 2ω[°] | 34.0 | 0.6 |
| Y | 4.45 | |

TABLE 11
Example 3

| | Wide | Tele |
|---|---|---|
| DD[6] | 3.12 | 97.94 |
| DD[14] | 95.49 | 0.67 |
| DD[22] | 3.07 | 30.67 |
| DD[29] | 33.01 | 5.42 |

TABLE 12
Example 3

| Sn | 15 | 16 | 30 | 31 |
|---|---|---|---|---|
| KA | 1.0000000E+00 | 1.0000000E+00 | 1.0000000E+00 | 1.0000000E+00 |
| A3 | 0.0000000E+00 | 8.4326836E−21 | 1.4705433E−20 | −8.6271874E−21 |
| A4 | −6.4069336E−06 | 3.4695349E−06 | −7.7733878E−07 | 9.3143684E−06 |
| A5 | 3.8909772E−07 | 4.1919621E−07 | −2.6094269E−06 | −2.3203159E−06 |
| A6 | 1.5979068E−08 | 2.2919374E−09 | 3.8048437E−08 | 7.1964048E−08 |
| A7 | −2.8798503E−09 | −1.5591686E−09 | 4.8779352E−08 | 3.9960023E−08 |
| A8 | −7.2369391E−11 | −5.6640693E−11 | 4.7627062E−10 | −2.9993011E−10 |
| A9 | 1.1713556E−11 | 5.1359614E−12 | −1.0867135E−09 | −7.5583929E−10 |
| A10 | 3.6244534E−13 | 4.3331373E−13 | 1.6126726E−11 | −1.0167132E−11 |
| A11 | −3.0354570E−14 | −1.2095044E−14 | 1.5504112E−11 | 1.3984530E−11 |
| A12 | −1.3047757E−15 | −1.6318478E−15 | −7.6843099E−13 | −1.2630224E−13 |
| A13 | 4.9385469E−17 | 1.8948601E−17 | −1.3682998E−13 | −1.8582519E−13 |
| A14 | 2.7643229E−18 | 3.3254297E−18 | 1.1093197E−14 | 6.5572289E−15 |
| A15 | −4.8752595E−20 | −1.8518121E−20 | 7.3483378E−16 | 1.4744748E−15 |
| A16 | −3.3050141E−21 | −3.7717600E−21 | −7.9745187E−17 | −7.7071970E−17 |
| A17 | 2.6667536E−23 | 1.0166081E−23 | −2.1906053E−18 | −6.1640990E−18 |
| A18 | 2.0752763E−24 | 2.2514236E−24 | 2.8893006E−19 | 3.8348590E−19 |
| A19 | −6.1975853E−27 | −2.3874545E−27 | 2.7824994E−21 | 1.0419283E−20 |
| A20 | −5.3352706E−28 | −5.5304790E−28 | −4.1695435E−22 | −7.0494583E−22 |

### Example 4

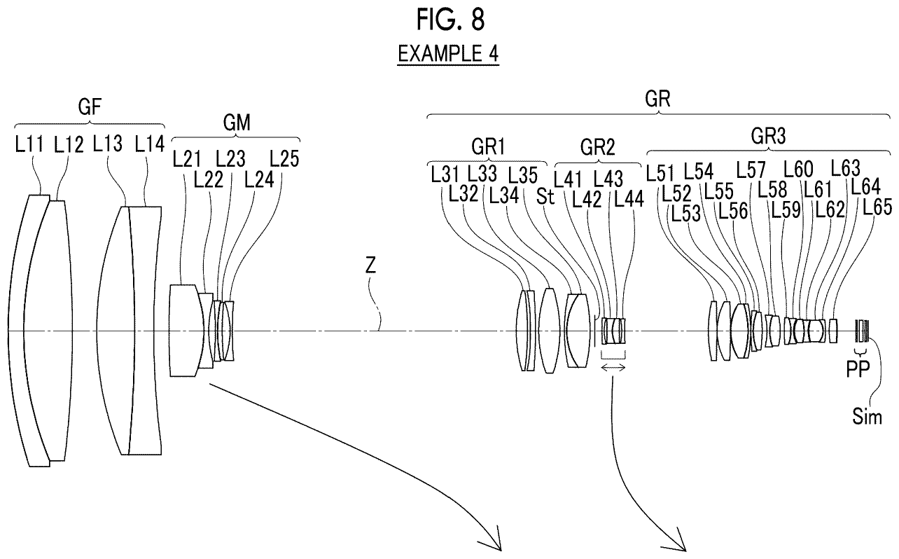

FIG. 8 shows a configuration and movement loci of the zoom lens of Example 4. The zoom lens of Example 4 consists of a front group GF, an intermediate group GM, and a rear group GR, in order from the object side to the image side. The front group GF consists of one lens group that has a positive refractive power. The intermediate group GM consists of one lens group that has a negative refractive power. The rear group GR consists of, in order from the object side to the image side, three lens groups including a first subsequent lens group GR1 that has a positive refractive power, a second subsequent lens group GR2 that has a negative refractive power, and a third subsequent lens group GR3 that has a positive refractive power. During zooming from the wide-angle end to the telephoto end, the front group GF, the first subsequent lens group GR1, and the third subsequent lens group GR3 remain stationary with respect to the image plane Sim, and the intermediate group GM and the second subsequent lens group GR2 move along the optical axis Z by changing the spacings between the adjacent lens groups.

The front group GF consists of four lenses L11 to L14, in order from the object side to the image side. The intermediate group GM consists of five lenses L21 to L25, in order from the object side to the image side. The first subsequent lens group GR1 consists of five lenses L31 to L35 and an aperture stop St, in order from the object side to the image side. The second subsequent lens group GR2 consists of four lenses L41 to L44, in order from the object side to the image side. The third subsequent lens group GR3 consists of 15 lenses L51 to L65, in order from the object side to the image side. The focusing group consists of the second subsequent lens group GR2.

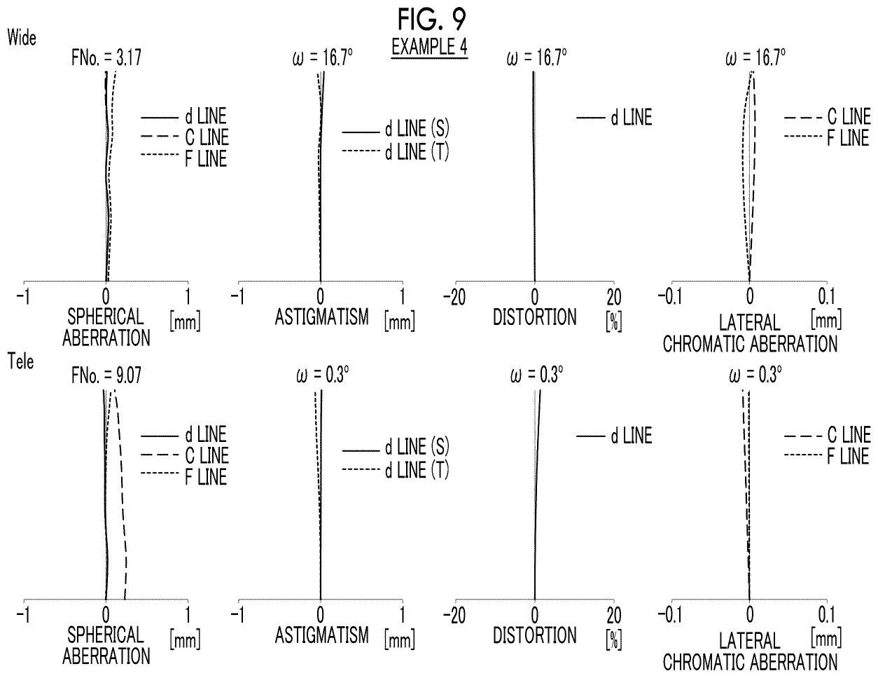

Regarding the zoom lens of Example 4, Tables 13A and 13B show basic lens data, Table 14 shows specification, Table 15 shows variable surface spacings, and Table 16 shows aspherical coefficients thereof. FIG. 9 shows aberration diagrams thereof.

TABLE 13A
Example 4

| Sn | R | D | Nd | νd |
|---|---|---|---|---|
| 1 | 190.1440 | 6.6675 | 1.80518 | 25.46 |
| 2 | 143.8589 | 20.8760 | 1.49700 | 81.61 |
| 3 | −453.0417 | 10.4135 | | |
| 4 | 138.5199 | 16.2831 | 1.49700 | 81.61 |
| 5 | −552.7561 | 8.2227 | 1.77250 | 49.62 |
| 6 | 383.0685 | DD[6] | | |
| 7 | 299.8818 | 15.0000 | 1.89286 | 20.36 |
| 8 | −50.7023 | 2.0738 | 1.65160 | 58.54 |
| 9 | 49.3895 | 2.8035 | | |
| 10 | −171.2639 | 1.0100 | 1.80400 | 46.58 |
| 11 | 63.0976 | 1.9810 | 1.90043 | 37.37 |
| 12 | 123.3247 | 3.3346 | | |
| 13 | −34.9445 | 1.0002 | 1.71299 | 53.87 |
| 14 | 149.7756 | DD[14] | | |
| 15 | 59.4532 | 4.7854 | 1.49700 | 81.61 |
| 16 | −136.5582 | 1.2650 | | |
| *17 | −244.0193 | 2.1880 | 1.51633 | 64.06 |
| *18 | −294.5579 | 1.4081 | | |
| 19 | 53.6618 | 9.0765 | 1.49700 | 81.61 |
| 20 | −57.0724 | 1.9187 | | |
| 21 | 72.2479 | 1.0449 | 1.80000 | 29.84 |
| 22 | 26.8727 | 9.9873 | 1.49700 | 81.61 |
| 23 | −67.0371 | 1.9839 | | |
| 24(St) | ∞ | DD[24] | | |
| 25 | 100.2859 | 1.0221 | 2.00100 | 29.13 |
| 26 | 18.4256 | 1.2409 | | |
| 27 | −89.4469 | 2.2562 | 1.75500 | 52.32 |
| 28 | 13.2979 | 2.9564 | 1.92286 | 20.88 |
| 29 | 465.6185 | 1.0524 | | |
| 30 | −25.1182 | 1.2956 | 1.90043 | 37.37 |
| 31 | 115.5237 | DD[31] | | |

TABLE 13B
Example 4

| Sn | R | D | Nd | νd |
|---|---|---|---|---|
| *32 | 52.2537 | 3.6617 | 1.51633 | 64.06 |
| *33 | −288.2367 | 0.0999 | | |
| 34 | 26.5634 | 5.7836 | 1.49700 | 81.61 |
| 35 | −228.2036 | 0.1429 | | |
| 36 | 22.6322 | 7.3560 | 1.49700 | 81.61 |
| 37 | −36.6601 | 1.1282 | 1.85883 | 30.00 |
| 38 | −59.9409 | 0.1053 | | |
| 39 | 92.3102 | 1.0050 | 1.90366 | 31.31 |
| 40 | 23.1162 | 3.7980 | 1.51823 | 58.90 |
| 41 | −62.1920 | 2.1047 | | |
| 42 | −28.5150 | 1.2141 | 1.85150 | 40.78 |
| 43 | 20.0540 | 4.4540 | 1.51742 | 52.43 |
| 44 | −28.5152 | 1.7441 | | |
| 45 | 75.3030 | 2.8426 | 1.89286 | 20.36 |
| 46 | −16.4475 | 1.1323 | 1.90043 | 37.37 |
| 47 | 11.9658 | 0.4111 | | |
| 48 | 9.9696 | 4.1342 | 1.57501 | 41.50 |
| 49 | −18.0007 | 1.7294 | 1.90043 | 37.37 |
| 50 | 13.3346 | 0.3680 | | |
| 51 | 16.5772 | 6.0346 | 1.68893 | 31.07 |
| 52 | −7.2680 | 1.0000 | 1.90043 | 37.37 |
| 53 | −40.9374 | 1.6147 | | |
| 54 | 30.0976 | 3.2323 | 1.51823 | 58.90 |
| 55 | −116.4360 | 8.2821 | | |
| 56 | ∞ | 0.6000 | 1.51680 | 64.20 |
| 57 | ∞ | 0.8000 | | |
| 58 | ∞ | 1.5500 | 1.51680 | 64.20 |
| 59 | ∞ | 0.8500 | | |
| 60 | ∞ | 0.7000 | 1.51680 | 64.20 |
| 61 | ∞ | 0.7100 | | |

TABLE 14
Example 4

| | Wide | Tele |
|---|---|---|
| Zr | 1.0 | 67.0 |
| f | 14.89 | 997.53 |
| Bf | 12.51 | 12.51 |
| FNo. | 3.17 | 9.07 |
| 2ω[°] | 33.4 | 0.6 |
| Y | 4.45 | |

TABLE 15
Example 4

| | Wide | Tele |
|---|---|---|
| DD[6] | 6.52 | 124.46 |
| DD[14] | 121.66 | 3.71 |
| DD[24] | 3.07 | 30.63 |
| DD[31] | 35.88 | 8.32 |

TABLE 16
Example 4

| Sn | 17 | 18 | 32 | 33 |
|---|---|---|---|---|
| KA | 1.0000000E+00 | 1.0000000E+00 | 1.0000000E+00 | 1.0000000E+00 |
| A3 | 1.2143064E−21 | −1.1275703E−21 | −1.8822954E−20 | −1.4117216E−20 |
| A4 | −1.4433774E−05 | −5.9726797E−06 | −1.4620962E−05 | −3.1932829E−06 |
| A5 | 1.9089245E−07 | 1.3285024E−07 | 1.4842904E−06 | 5.2268705E−08 |
| A6 | −3.2319483E−08 | −2.4036628E−08 | −2.3449996E−07 | 2.2446983E−07 |
| A7 | −1.7409936E−09 | −1.1188317E−09 | −4.3422881E−08 | −6.4961359E−08 |
| A8 | 5.6784563E−10 | 4.6483252E−10 | 3.3707102E−08 | 1.2639022E−08 |
| A9 | 9.4062010E−12 | 5.3382827E−12 | −5.9555689E−10 | 2.2797526E−09 |
| A10 | −3.5598661E−12 | −2.7423838E−12 | −9.2072583E−10 | −5.5772049E−10 |
| A11 | −3.0005189E−14 | −1.4746207E−14 | 3.1876261E−11 | −3.9912698E−11 |
| A12 | 1.3949088E−14 | 1.0201734E−14 | 1.2944334E−11 | 1.0106115E−11 |
| A13 | 5.9007756E−17 | 2.4564018E−17 | −4.9294700E−13 | 3.8999251E−13 |
| A14 | −3.4280427E−17 | −2.4055281E−17 | −1.0581234E−13 | −1.0120094E−13 |
| A15 | −7.0792263E−20 | −2.4287062E−20 | 3.8460518E−15 | −2.1323019E−15 |
| A16 | 5.0553670E−20 | 3.4295294E−20 | 5.0034578E−16 | 5.8015269E−16 |
| A17 | 4.7766635E−23 | 1.3035969E−23 | −1.5352170E−17 | 6.0147257E−18 |
| A18 | −4.0808387E−23 | −2.6924479E−23 | −1.2501065E−18 | −1.7832238E−18 |
| A19 | −1.3951826E−26 | −2.8880116E−27 | 2.4946728E−20 | −6.6779000E−21 |
| A20 | 1.3846880E−26 | 8.9276669E−27 | 1.2392024E−21 | 2.2789463E−21 |

### Example 5

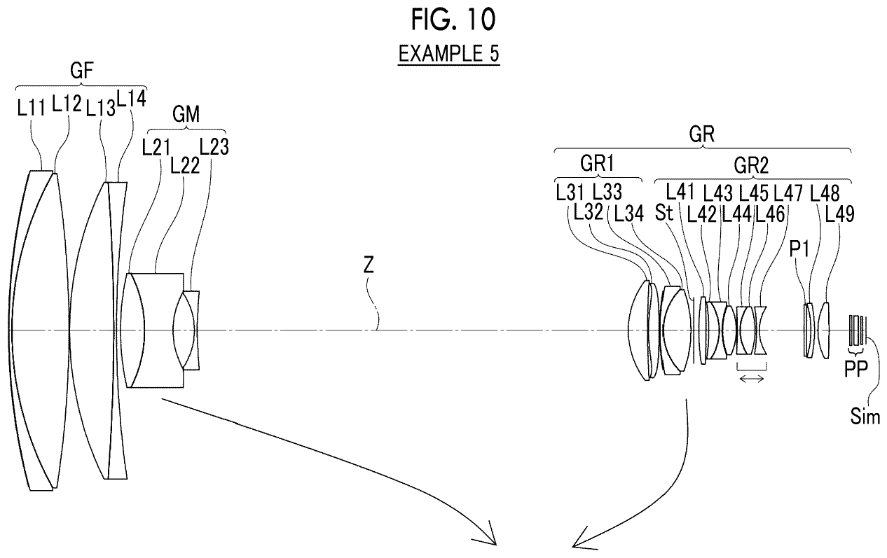

FIG. 10 shows a configuration and movement loci of a zoom lens of Example 5. The zoom lens of Example 5 consists of a front group GF, an intermediate group GM, and a rear group GR, in order from the object side to the image side. The front group GF consists of one lens group that has a positive refractive power. The intermediate group GM consists of one lens group that has a negative refractive power. The rear group GR consists of, in order from the object side to the image side, two lens groups including a first subsequent lens group GR1 that has a positive refractive power and a second subsequent lens group GR2 that has a negative refractive power. During zooming from the wide-angle end to the telephoto end, the front group GF and the second subsequent lens group GR2 remain stationary with respect to the image plane Sim, and the intermediate group GM and the first subsequent lens group GR1 move along the optical axis Z by changing the spacings between the adjacent lens groups.

The front group GF consists of four lenses L11 to L14, in order from the object side to the image side. The intermediate group GM consists of three lenses L21 to L23, in order from the object side to the image side. The first subsequent lens group GR1 consists of four lenses L31 to L34, in order from the object side to the image side. The second subsequent lens group GR2 consists of an aperture stop St, lenses L41 to L47, a filter P1, and lenses L48 and L49, in order from the object side to the image side. The focusing group consists of three lenses L45 to L47.

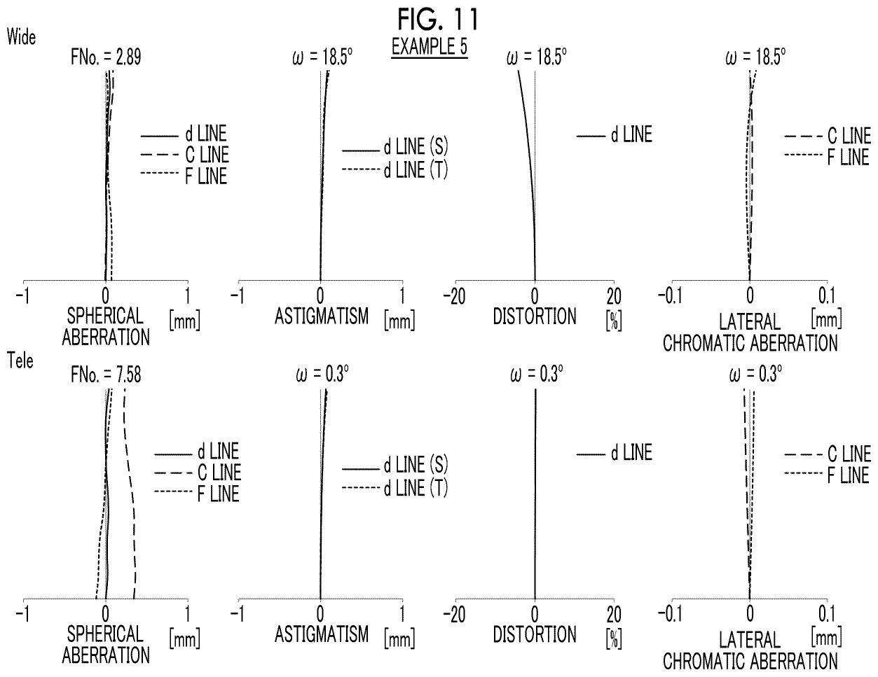

Regarding the zoom lens of Example 5, Table 17 shows basic lens data, Table 18 shows specifications, Table 19 shows variable surface spacings, and Table 20 shows aspherical coefficients thereof. FIG. 11 shows aberration diagrams thereof.

TABLE 17
Example 5

| Sn | R | D | Nd | νd |
|---|---|---|---|---|
| 1 | 215.2881 | 1.0200 | 1.51680 | 64.20 |
| 2 | 112.4813 | 20.0583 | 1.49700 | 81.61 |
| 3 | −354.1377 | 0.2000 | | |
| 4 | 117.5491 | 15.4841 | 1.49700 | 81.61 |
| 5 | −697.9575 | 1.0000 | 1.84999 | 31.50 |
| 6 | 365.6764 | DD[6] | | |
| 7 | 89.2890 | 8.4696 | 1.84999 | 22.50 |
| 8 | −44.1422 | 10.0156 | 1.84999 | 41.06 |
| 9 | 27.6238 | 7.4951 | | |
| *10 | −26.6925 | 1.0000 | 1.58313 | 59.46 |
| *11 | 68.0245 | DD[11] | | |
| 12 | 28.8407 | 6.8007 | 1.59684 | 65.10 |
| 13 | 300.0107 | 0.2791 | | |
| *14 | 47.7932 | 3.7403 | 1.49710 | 81.56 |
| *15 | −211.5914 | 0.3283 | | |
| 16 | 76.7956 | 1.0000 | 1.86980 | 38.49 |
| 17 | 20.4012 | 9.6839 | 1.49700 | 81.61 |
| 18 | −42.0728 | DD[18] | | |
| 19(St) | ∞ | 1.8000 | | |
| 20 | 81.3782 | 2.5399 | 1.73974 | 28.01 |
| 21 | −244.3696 | 0.9653 | | |
| 22 | −67.3532 | 3.6636 | 1.52001 | 52.82 |
| 23 | −18.1297 | 1.0000 | 1.84999 | 41.05 |
| 24 | 24.5174 | 0.2000 | | |
| 25 | 23.6119 | 4.7814 | 1.55795 | 44.13 |
| 26 | −20.8789 | 0.4000 | | |
| 27 | −117.6425 | 0.9700 | 1.84999 | 43.00 |
| 28 | 15.0691 | 5.2475 | 1.65575 | 33.16 |
| 29 | −26.1803 | 0.4987 | | |
| 30 | −52.0553 | 1.0000 | 1.78466 | 49.53 |
| 31 | 15.0022 | 15.6532 | | |
| 32 | ∞ | 1.0000 | 1.51680 | 64.20 |
| 33 | ∞ | 1.4697 | | |
| 34 | −32.6903 | 1.2639 | 1.84999 | 22.50 |
| 35 | −48.1152 | 1.1923 | | |
| 36 | 21.8784 | 3.8948 | 1.66450 | 34.14 |
| 37 | −233.2844 | 7.3300 | | |
| 38 | ∞ | 0.6000 | 1.51680 | 64.20 |
| 39 | ∞ | 0.8000 | | |
| 40 | ∞ | 1.5500 | 1.51680 | 64.20 |
| 41 | ∞ | 0.8500 | | |
| 42 | ∞ | 0.7000 | 1.51680 | 64.20 |
| 43 | ∞ | 1.2100 | | |

TABLE 18
Example 5

| | Wide | Tele |
|---|---|---|
| Zr | 1.0 | 57.0 |
| f | 14.55 | 829.18 |
| Bf | 1.22 | 1.22 |
| FNo. | 2.89 | 7.58 |
| 2ω[°] | 37.0 | 0.6 |
| Y | 4.67 | |

TABLE 19
Example 5

| | Wide | Tele |
|---|---|---|
| DD[6] | 1.41 | 118.38 |
| DD[11] | 151.30 | 0.97 |
| DD[18] | 0.98 | 34.34 |

TABLE 20
Example 5

| Sn | 10 | 11 | 14 | 15 |
|---|---|---|---|---|
| KA | 1.0000000E+00 | 1.0000000E+00 | 1.0000000E+00 | 1.0000000E+00 |
| A3 | 1.3908133E−20 | −1.5172509E−20 | 2.1625515E−19 | −7.7233981E−20 |
| A4 | −1.2549382E−04 | −1.2574593E−04 | −1.9601635E−05 | −5.4550320E−06 |
| A5 | 1.6102357E−05 | 1.4250672E−05 | 1.0445875E−06 | 1.3564136E−06 |
| A6 | −9.7992847E−07 | −4.2990876E−07 | −2.4002717E−07 | −2.9784489E−07 |
| A7 | −5.8648688E−08 | −1.0433727E−07 | 3.0657685E−08 | 4.0273203E−08 |
| A8 | 2.2601423E−08 | 1.6188300E−08 | −1.6322094E−10 | −1.9862934E−10 |
| A9 | 2.5651675E−10 | 1.3380679E−09 | −3.3850308E−10 | −5.1883653E−10 |
| A10 | −3.1889039E−10 | −2.6166819E−10 | 3.2797586E−12 | 1.1446302E−11 |
| A11 | −4.2454035E−12 | −2.3535801E−11 | 2.9827746E−12 | 4.8324502E−12 |
| A12 | 3.0386569E−12 | 3.3159114E−12 | −3.4931718E−14 | −1.5093750E−13 |
| A13 | 4.6025421E−14 | 2.3728858E−13 | −1.6360368E−14 | −2.7294286E−14 |
| A14 | −1.8483399E−14 | −2.7904493E−14 | 1.3474417E−16 | 9.2625521E−16 |
| A15 | −3.0067359E−16 | −1.3501598E−15 | 5.4304645E−17 | 9.1981557E−17 |
| A16 | 7.2290272E−17 | 1.4587948E−16 | −1.1600946E−19 | −3.0504064E−18 |
| A17 | 1.0244835E−18 | 4.0574105E−18 | −9.9747522E−20 | −1.7024726E−19 |
| A18 | −1.7031602E−19 | −4.2567271E−19 | −5.5053869E−22 | 5.1340682E−21 |
| A19 | −1.4035076E−21 | −5.0065393E−21 | 7.7778213E−23 | 1.3325485E−22 |
| A20 | 1.8669798E−22 | 5.2708089E−22 | 1.1202109E−24 | −3.3863481E−24 |

### Example 6

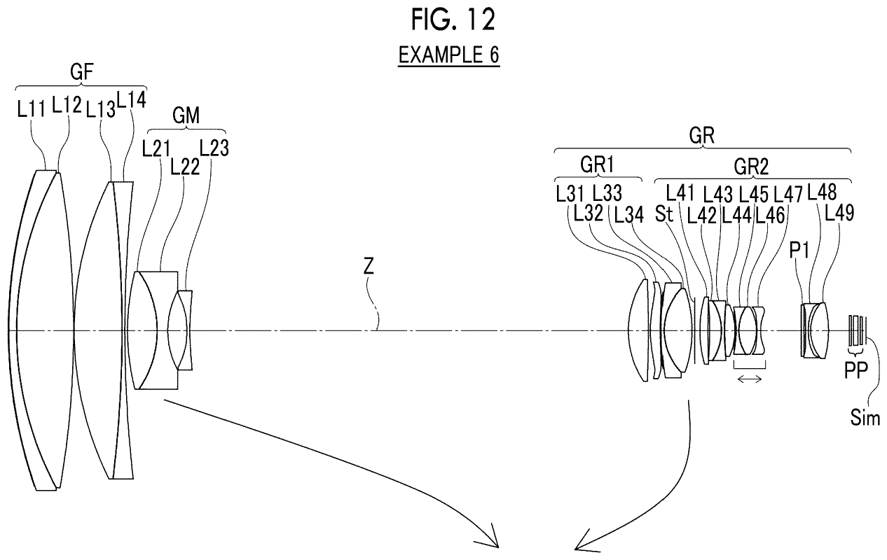

FIG. 12 shows a configuration and movement loci of a zoom lens of Example 6. The zoom lens of Example 6 consists of a front group GF, an intermediate group GM, and a rear group GR, in order from the object side to the image side. The front group GF consists of one lens group that has a positive refractive power. The intermediate group GM consists of one lens group that has a negative refractive power. The rear group GR consists of, in order from the object side to the image side, two lens groups including a first subsequent lens group GR1 that has a positive refractive power and a second subsequent lens group GR2 that has a negative refractive power. During zooming from the wide-angle end to the telephoto end, the front group GF and the second subsequent lens group GR2 remain stationary with respect to the image plane Sim, and the intermediate group GM and the first subsequent lens group GR1 move along the optical axis Z by changing the spacings between the adjacent lens groups.

The front group GF consists of four lenses L11 to L14, in order from the object side to the image side. The intermediate group GM consists of three lenses L21 to L23, in order from the object side to the image side. The first subsequent lens group GR1 consists of four lenses L31 to L34, in order from the object side to the image side. The second subsequent lens group GR2 consists of an aperture stop St, lenses L41 to L47, a filter P1, and lenses L48 and L49, in order from the object side to the image side. The focusing group consists of three lenses L45 to L47.

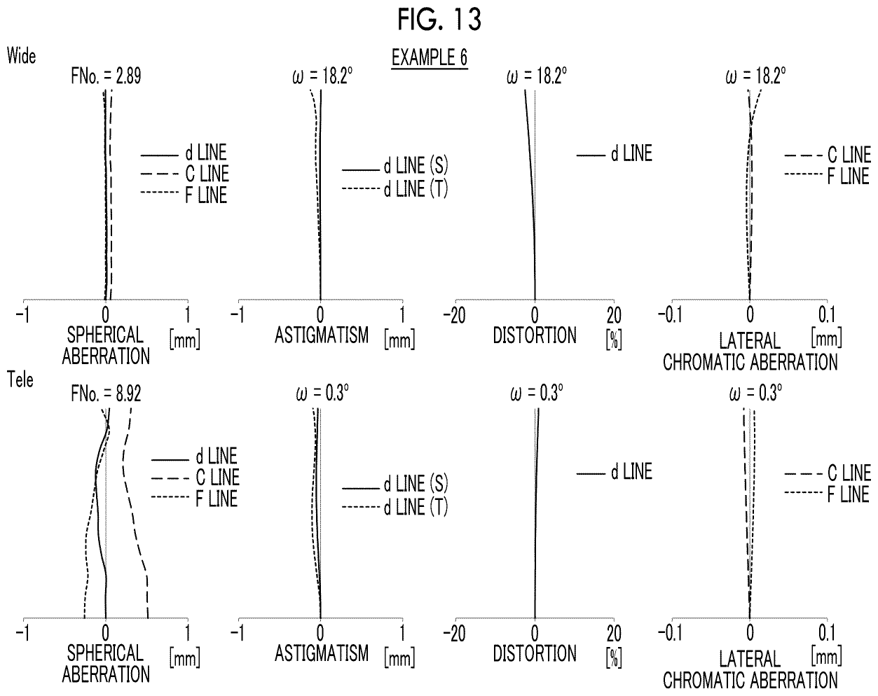

Regarding the zoom lens of Example 6, Table 21 shows basic lens data, Table 22 shows specifications, Table 23 shows variable surface spacings, and Table 24 shows aspherical coefficients thereof. FIG. 13 shows aberration diagrams thereof.

TABLE 21
Example 6

| Sn | R | D | Nd | νd |
|---|---|---|---|---|
| 1 | 167.3167 | 2.7210 | 1.51680 | 64.20 |
| 2 | 116.0664 | 20.0120 | 1.43700 | 95.10 |
| 3 | −320.2512 | 0.2001 | | |
| 4 | 116.7744 | 16.8094 | 1.49700 | 81.61 |
| 5 | −430.1466 | 1.0001 | 1.84990 | 33.36 |
| 6 | 463.2843 | DD[6] | | |
| 7 | 82.7717 | 10.4228 | 1.84990 | 22.51 |
| 8 | −36.0013 | 3.7154 | 1.79560 | 47.64 |
| 9 | 28.9449 | 6.7088 | | |
| *10 | −47.0446 | 1.0001 | 1.80610 | 40.73 |
| *11 | 40.7756 | DD[11] | | |
| 12 | 32.2731 | 7.0285 | 1.73325 | 54.67 |
| 13 | −484.2106 | 0.6914 | | |
| *14 | 42.2630 | 3.5403 | 1.58313 | 59.46 |
| *15 | 175.2210 | 0.1868 | | |
| 16 | 98.9740 | 1.0007 | 1.91090 | 36.17 |
| 17 | 20.8165 | 9.7305 | 1.43700 | 95.10 |
| 18 | −44.6903 | DD[18] | | |
| 19(St) | ∞ | 1.8001 | | |
| 20 | 43.5559 | 2.8574 | 1.82376 | 23.93 |
| 21 | 415.9484 | 0.5440 | | |
| 22 | −133.2437 | 4.1718 | 1.53021 | 49.34 |
| 23 | −18.8928 | 1.0002 | 1.90366 | 31.31 |
| 24 | 80.3875 | 0.2001 | | |
| 25 | 132.3844 | 3.5384 | 1.59492 | 38.51 |
| 26 | −22.9220 | 0.4002 | | |
| 27 | −40.8556 | 0.9701 | 1.84990 | 42.68 |
| 28 | 15.0028 | 6.1715 | 1.63090 | 34.94 |
| 29 | −16.3554 | 0.2001 | | |
| *30 | −28.6465 | 1.2901 | 1.80610 | 40.73 |
| *31 | 19.4835 | 14.2362 | | |
| 32 | ∞ | 1.0000 | 1.51680 | 64.20 |
| 33 | ∞ | 0.5425 | | |
| *34 | −37.8085 | 1.0001 | 1.80610 | 40.73 |
| *35 | 41.5025 | 0.7896 | | |
| 36 | 15.0237 | 6.2829 | 1.67417 | 33.13 |
| 37 | −37.5425 | 7.3300 | | |
| 38 | ∞ | 0.6000 | 1.51680 | 64.20 |
| 39 | ∞ | 0.8000 | | |
| 40 | ∞ | 1.5500 | 1.51680 | 64.20 |
| 41 | ∞ | 0.8500 | | |
| 42 | ∞ | 0.7000 | 1.51680 | 64.20 |
| 43 | ∞ | 1.3800 | | |

TABLE 22
Example 6

| | Wide | Tele |
|---|---|---|
| Zr | 1.0 | 67.0 |
| f | 14.55 | 974.87 |
| Bf | 1.38 | 1.38 |
| FNo. | 2.89 | 8.92 |
| 2ω[°] | 36.4 | 0.6 |
| Y | 4.67 | |

TABLE 23
Example 6

| | Wide | Tele |
|---|---|---|
| DD[6] | 0.95 | 111.30 |
| DD[11] | 153.97 | 0.96 |
| DD[18] | 0.98 | 43.64 |

TABLE 24
Example 6

| Sn | 10 | 11 | 14 | 15 |
|---|---|---|---|---|
| KA | 1.0000000E+00 | 1.0000000E+00 | 1.0000000E+00 | 1.0000000E+00 |
| A3 | −2.0230011E−19 | 1.2138007E−19 | −1.5229397E−19 | 1.5229397E−19 |
| A4 | −3.8192329E−04 | −3.8511602E−04 | −2.1845360E−05 | −1.5023165E−05 |
| A5 | 4.5404653E−05 | 4.7272322E−05 | 7.9731280E−06 | 1.0201418E−05 |
| A6 | 4.2697031E−06 | 3.8423771E−06 | −1.7579574E−06 | −2.4241529E−06 |
| A7 | −1.4244389E−06 | −1.4032629E−06 | 6.2939414E−08 | 1.2024178E−07 |
| A8 | −2.6968190E−09 | 1.6566639E−08 | 2.8852186E−08 | 3.8030134E−08 |
| A9 | 3.2015452E−08 | 2.8139193E−08 | −3.2622969E−09 | −5.1689200E−09 |
| A10 | −1.4811913E−09 | −1.6076134E−09 | −1.7815788E−10 | −1.8684481E−10 |
| A11 | −4.3127304E−10 | −3.5121623E−10 | 4.0753447E−11 | 6.2349463E−11 |
| A12 | 3.0120927E−11 | 2.8544652E−11 | −6.5307494E−14 | −7.7388834E−13 |
| A13 | 3.5037166E−12 | 2.6880375E−12 | −2.5156235E−13 | −3.7809909E−13 |
| A14 | −2.9071213E−13 | −2.5871192E−13 | 6.1822381E−15 | 1.2688947E−14 |
| A15 | −1.6926825E−14 | −1.2351757E−14 | 8.4706982E−16 | 1.2579813E−15 |
| A16 | 1.5364733E−15 | 1.3180185E−15 | −3.1566316E−17 | −5.7678304E−17 |
| A17 | 4.4779945E−17 | 3.1276503E−17 | −1.4894027E−18 | −2.1917482E−18 |
| A18 | −4.2655787E−18 | −3.5837692E−18 | 6.7680629E−20 | 1.1874016E−19 |
| A19 | −4.9969992E−20 | −3.3551521E−20 | 1.0717579E−21 | 1.5655512E−21 |
| A20 | 4.8648880E−21 | 4.0492667E−21 | −5.4941354E−23 | −9.4527368E−23 |

| Sn | 30 | 31 | 34 | 35 |
|---|---|---|---|---|
| KA | 1.0000000E+00 | 1.0000000E+00 | 1.0000000E+00 | 1.0000000E+00 |
| A3 | 4.4408921E−19 | 5.5511151E−19 | 0.0000000E+00 | 2.5898190E−19 |
| A4 | −5.6914374E−05 | −9.2929310E−05 | 5.2883097E−04 | 5.8722152E−04 |
| A5 | 3.7916797E−04 | 4.4947893E−04 | −1.5858895E−05 | −2.6035741E−05 |
| A6 | −8.5812340E−05 | −9.1402857E−05 | −1.1597294E−07 | −1.1311170E−06 |
| A7 | −1.4627877E−05 | −2.1580671E−05 | 4.0930221E−07 | 1.5623246E−06 |
| A8 | 6.1161780E−06 | 7.6433493E−06 | −2.0229391E−07 | −3.5251518E−07 |
| A9 | 2.1667752E−07 | 5.5861739E−07 | −2.4765614E−09 | −4.4293707E−09 |
| A10 | −2.3604273E−07 | −3.4460092E−07 | 1.6365388E−09 | 2.7187161E−09 |
| A11 | 1.4869482E−09 | −7.6423412E−09 | 0.0000000E+00 | 0.0000000E+00 |
| A12 | 5.6984828E−09 | 9.4055677E−09 | 0.0000000E+00 | 0.0000000E+00 |
| A13 | −1.0959580E−10 | 2.8634697E−11 | 0.0000000E+00 | 0.0000000E+00 |
| A14 | −8.7754743E−11 | −1.5801531E−10 | 0.0000000E+00 | 0.0000000E+00 |
| A15 | 1.6991282E−12 | 4.8654829E−13 | 0.0000000E+00 | 0.0000000E+00 |
| A16 | 8.3268559E−13 | 1.5834204E−12 | 0.0000000E+00 | 0.0000000E+00 |
| A17 | −1.1671868E−14 | −5.8596530E−15 | 0.0000000E+00 | 0.0000000E+00 |
| A18 | −4.4117027E−15 | −8.6366215E−15 | 0.0000000E+00 | 0.0000000E+00 |
| A19 | 3.0798365E−17 | 1.8890543E−17 | 0.0000000E+00 | 0.0000000E+00 |
| A20 | 9.9408383E−18 | 1.9674080E−17 | 0.0000000E+00 | 0.0000000E+00 |

### Example 7

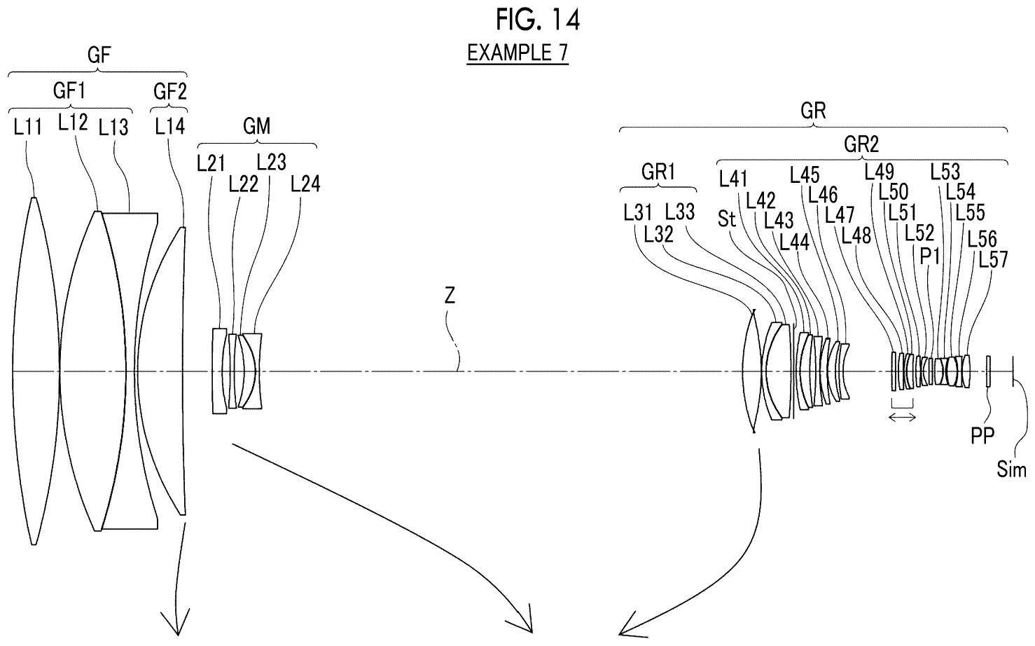

FIG. 14 shows a configuration and movement loci of the zoom lens of Example 7. The zoom lens of Example 7 consists of a front group GF, an intermediate group GM, and a rear group GR, in order from the object side to the image side. The front group GF consists of, in order from the object side to the image side, two lens groups including a first front side lens group GF1 that has a positive refractive power and a second front side lens group GF2 that has a positive refractive power. The intermediate group GM consists of one lens group that has a negative refractive power. The rear group GR consists of, in order from the object side to the image side, two lens groups including a first subsequent lens group GR1 that has a positive refractive power and a second subsequent lens group GR2 that has a negative refractive power. During zooming from the wide-angle end to the telephoto end, the first front side lens group GF1 and the second subsequent lens group GR2 remain stationary with respect to the image plane Sim, and the second front side lens group GF2, the intermediate group GM, and the first subsequent lens group GR1 move along the optical axis Z by changing the spacings between the adjacent lens groups.

The first front side lens group GF1 consists of three lenses L11 to L13, in order from the object side to the image side. The second front side lens group GF2 consists of one lens L14. The intermediate group GM consists of four lenses L21 to L24, in order from the object side to the image side. The first subsequent lens group GR1 consists of three lenses L31 to L33, in order from the object side to the image side. The second subsequent lens group GR2 consists of an aperture stop St, lenses L41 to L52, a filter P1, and lenses L53 to L57, in order from the object side to the image side. The focusing group consists of four lenses L47 to L50.

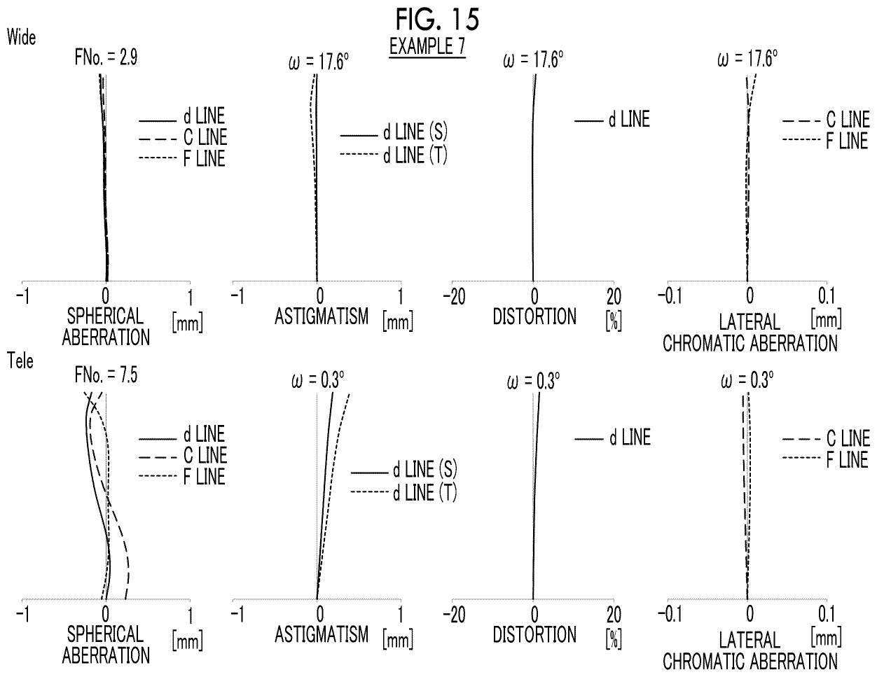

Regarding the zoom lens of Example 7, Tables 25A and 25B show basic lens data, Table 26 shows specification, Table 27 shows variable surface spacings, and Table 28 shows aspherical coefficients thereof. FIG. 15 shows aberration diagrams thereof.

TABLE 25A
Example 7

| Sn | R | D | Nd | νd |
|---|---|---|---|---|
| 1 | 270.9874 | 14.0514 | 1.51122 | 78.27 |
| 2 | −219.0967 | 0.1256 | | |
| 3 | 128.3875 | 19.8509 | 1.48856 | 81.48 |
| 4 | −175.3735 | 2.5192 | 1.80627 | 47.05 |
| 5 | 161.0078 | DD[5] | | |
| 6 | 87.1170 | 13.5146 | 1.47118 | 83.06 |
| 7 | 1289.4215 | DD[7] | | |
| *8 | 647.5762 | 2.9866 | 1.69770 | 56.61 |
| *9 | 54.5943 | 2.3711 | | |
| 10 | −176.6265 | 1.2159 | 1.74939 | 53.06 |
| 11 | 96.3605 | 3.0218 | | |
| 12 | −36.5399 | 3.3604 | 1.90956 | 19.52 |
| 13 | −18.8811 | 1.2102 | 1.78876 | 49.12 |
| 14 | 99.1313 | DD[14] | | |
| *15 | 58.4686 | 5.6183 | 1.49710 | 81.56 |
| *16 | −65.3425 | 0.1217 | | |
| 17 | 40.6268 | 1.3591 | 1.87440 | 29.76 |
| 18 | 25.2752 | 7.4361 | 1.48317 | 82.59 |
| 19 | −204.4595 | DD[19] | | |
| 20(St) | ∞ | 0.7122 | | |
| 21 | 61.0593 | 1.2001 | 1.43001 | 68.12 |
| 22 | 27.5250 | 2.9300 | 1.50407 | 75.42 |
| 23 | 81.7295 | 1.7438 | | |
| 24 | −120.2220 | 1.2067 | 1.81482 | 46.05 |
| 25 | 64.6387 | 0.1202 | | |
| 26 | 29.6286 | 2.1449 | 1.90618 | 19.80 |
| 27 | 64.4798 | 0.1201 | | |
| 28 | 19.0111 | 2.3466 | 1.49142 | 72.15 |
| 29 | 31.9871 | 1.0730 | | |
| 30 | 56.4259 | 1.2002 | 1.90999 | 30.35 |
| 31 | 19.1363 | 14.6000 | | |
| 32 | 166.1915 | 1.2002 | 1.55659 | 44.39 |
| 33 | −369.7628 | 0.8159 | | |
| 34 | 33.4343 | 1.5831 | 1.43001 | 68.12 |
| 35 | 3422.6674 | 0.1201 | | |

TABLE 25B
Example 7

| Sn | R | D | Nd | νd |
|---|---|---|---|---|
| 36 | 20.1558 | 0.8001 | 1.90651 | 19.67 |
| 37 | 14.2548 | 1.8526 | 1.68082 | 41.39 |
| 38 | 58.9909 | 0.9300 | | |
| 39 | 43.0755 | 1.3335 | 1.78426 | 26.77 |
| 40 | −222.5791 | 0.2288 | | |
| 41 | 26.9791 | 0.7003 | 1.82460 | 42.97 |
| 42 | 8.3645 | 1.6885 | | |
| 43 | ∞ | 1.0000 | 1.51680 | 64.20 |
| 44 | ∞ | 0.6666 | | |
| 45 | 30.2506 | 2.5494 | 1.43000 | 68.12 |
| 46 | −9.9396 | 0.8002 | 1.85003 | 42.33 |
| 47 | 13.0820 | 0.3858 | | |
| 48 | 16.9176 | 3.0653 | 1.57316 | 41.28 |
| 49 | −10.9665 | 0.1271 | | |
| 50 | −16.4199 | 1.2002 | 1.86578 | 40.34 |
| 51 | 124.0175 | 0.1621 | | |
| 52 | 16.3464 | 2.3299 | 1.69200 | 30.57 |
| 53 | −45.2801 | 5.0000 | | |
| 54 | ∞ | 1.0000 | 1.51633 | 64.05 |
| 55 | ∞ | 6.9546 | | |

TABLE 26
Example 7

| | Wide | Tele |
|---|---|---|
| Zr | 1.00 | 57.00 |
| f | 14.53 | 827.49 |
| Bf | 12.62 | 12.68 |
| FNo. | 2.9 | 7.5 |
| 2ω[°] | 35.2 | 0.6 |
| Y | 4.65 | |

TABLE 27
Example 7

| | Wide | Tele |
|---|---|---|
| DD[5] | 0.97 | 8.89 |
| DD[7] | 8.89 | 92.94 |
| DD[14] | 145.00 | 0.93 |
| DD[19] | 0.83 | 52.93 |

TABLE 28
Example 7

| Sn | 8 | 9 | 15 | 16 |
|---|---|---|---|---|
| KA | 1.0000000E+00 | 1.0000000E+00 | 1.0000000E+00 | 1.0000000E+00 |
| A3 | 1.5830279E−05 | 1.7800161E−05 | 1.5287583E−05 | 1.7151489E−05 |
| A4 | 9.5030393E−07 | 6.8721054E−07 | 7.1179650E−08 | 9.3853640E−07 |
| A5 | 9.6420217E−08 | 8.5864173E−08 | −3.2679307E−08 | 2.9046684E−08 |
| A6 | 1.3527176E−09 | 3.4143803E−10 | 2.7373704E−10 | 2.9104740E−10 |
| A7 | 2.6550743E−11 | 5.2570916E−10 | 1.3216346E−10 | −3.8976669E−11 |
| A8 | 7.7064854E−12 | 1.0668034E−11 | 4.6146211E−12 | 2.7070293E−12 |
| A9 | 3.6025658E−13 | 3.0635527E−12 | −1.9794321E−13 | 4.8934621E−13 |
| A10 | 3.9347141E−14 | −3.3703439E−13 | 5.6056036E−15 | −9.5874213E−15 |
| A11 | 3.7699520E−15 | −6.9643483E−15 | 5.5804118E−16 | −5.1598395E−16 |
| A12 | −2.7297027E−16 | 7.4353186E−16 | −7.6435714E−18 | 3.2268775E−17 |
| A13 | −1.3585792E−17 | 7.2951158E−17 | −2.7699780E−18 | 4.9074764E−19 |
| A14 | −3.4645082E−18 | 1.4643621E−17 | 2.2760523E−20 | −1.9327224E−19 |
| A15 | −2.4341682E−19 | 1.0044652E−18 | −1.9753562E−20 | −1.0341968E−20 |
| A16 | 2.8185198E−20 | −3.2619340E−19 | −4.5463912E−22 | 1.8966525E−22 |
| A17 | −5.1987712E−21 | −1.3649245E−21 | 4.9352306E−23 | 1.3255614E−23 |
| A18 | 8.5129634E−23 | −8.6170587E−22 | 3.6754963E−25 | −1.4242248E−24 |
| A19 | 1.6793188E−23 | −6.8683642E−25 | 1.4685284E−25 | −3.7756960E−26 |
| A20 | −7.4002946E−27 | 9.1729947E−24 | −2.2297325E−27 | 1.1014891E−26 |

### Example 8

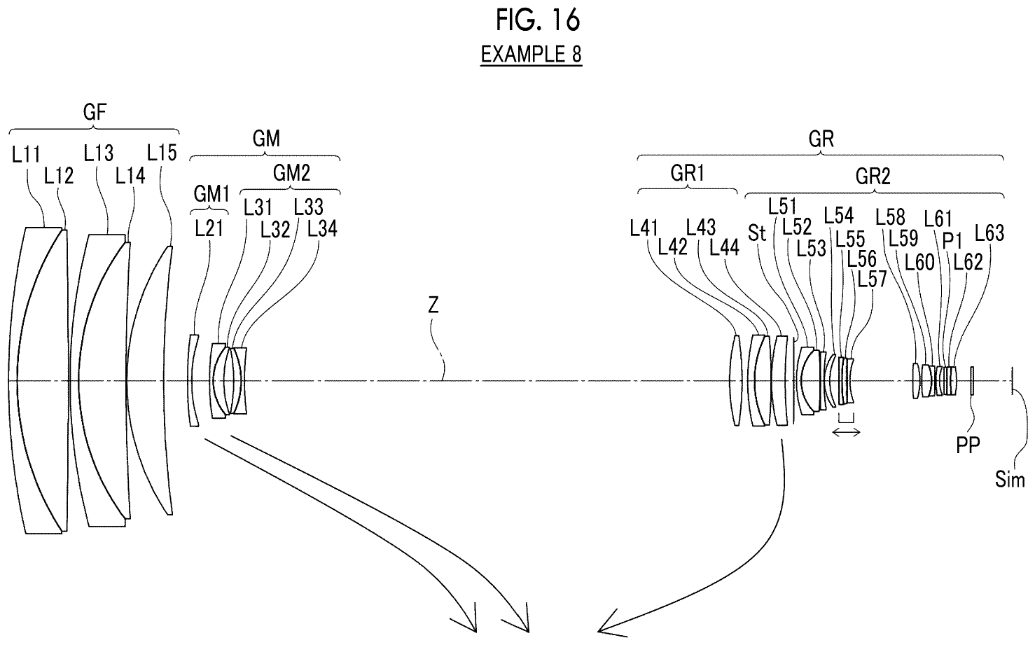

FIG. 16 shows a configuration and movement loci of the zoom lens of Example 8. The zoom lens of Example 8 consists of a front group GF, an intermediate group GM, and a rear group GR, in order from the object side to the image side. The front group GF consists of one lens group that has a positive refractive power. The intermediate group GM consists of, in order from the object side to the image side, two lens groups including a first intermediate lens group GM1 that has a negative refractive power and a second intermediate lens group GM2 that has a negative refractive power. The rear group GR consists of, in order from the object side to the image side, two lens groups including a first subsequent lens group GR1 that has a positive refractive power and a second subsequent lens group GR2 that has a negative refractive power. During zooming from the wide-angle end to the telephoto end, the front group GF and the second subsequent lens group GR2 remain stationary with respect to the image plane Sim, and the first intermediate lens group GM1, the second intermediate lens group GM2, and the first subsequent lens group GR1 move along the optical axis Z by changing the spacings between the lens groups adjacent to each other.

The front group GF consists of five lenses L11 to L15, in order from the object side to the image side. The first intermediate lens group GM1 consists of one lens L21. The second intermediate lens group GM2 consists of four lenses L31 to L34, in order from the object side to the image side. The first subsequent lens group GR1 consists of four lenses L41 to L44, in order from the object side to the image side. The second subsequent lens group GR2 consists of an aperture stop St, lenses L51 to L61, a filter P1, and lenses L62 and L63, in order from the object side to the image side. The focusing group consists of three lenses L55 to L57.

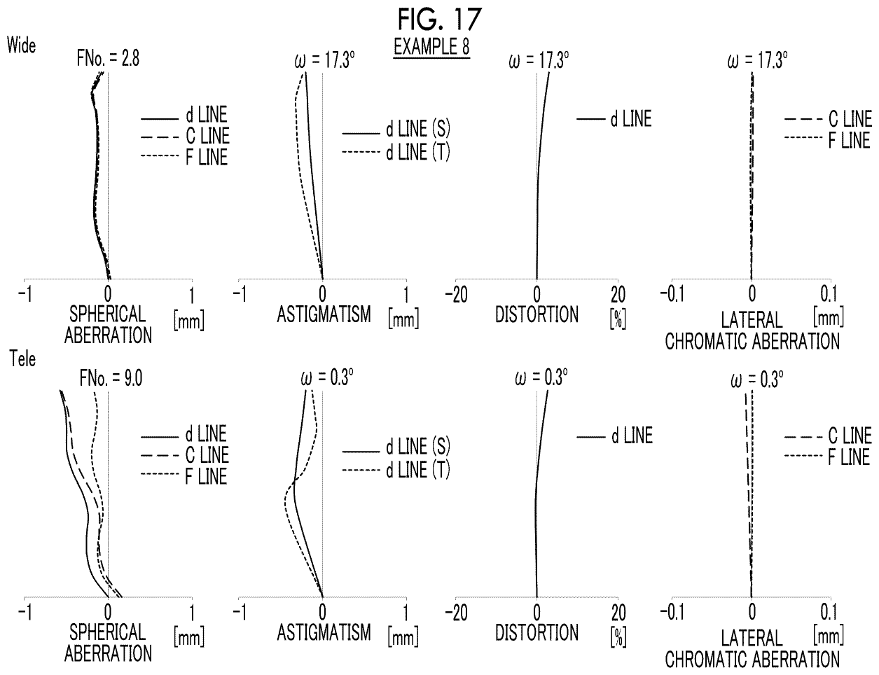

Regarding the zoom lens of Example 8, Tables 29A and 29B show basic lens data, Table 30 shows specification, Table 31 shows variable surface spacings, and Table 32 shows aspherical coefficients thereof. FIG. 17 shows aberration diagrams thereof.

TABLE 29A
Example 8

| Sn | R | D | Nd | νd |
|---|---|---|---|---|
| 1 | 242.0119 | 3.0014 | 1.51727 | 59.71 |
| 2 | 96.5960 | 17.8922 | 1.61612 | 61.93 |
| 3 | −2770.8574 | 0.6388 | | |
| 4 | 198.6458 | 3.0183 | 1.83481 | 42.73 |
| 5 | 79.8489 | 16.5614 | 1.43700 | 95.10 |
| 6 | 789.5321 | 0.2957 | | |
| 7 | 84.0040 | 12.9061 | 1.43700 | 95.10 |
| 8 | 358.5406 | DD[8] | | |
| *9 | 163.2521 | 1.4833 | 1.82318 | 45.28 |
| *10 | 53.4631 | DD[10] | | |
| 11 | 85.2718 | 1.3103 | 1.75163 | 41.22 |
| 12 | 18.4240 | 3.7246 | 1.89743 | 20.11 |
| 13 | 35.4800 | 3.4429 | | |
| 14 | −55.4280 | 2.5931 | 1.87310 | 21.26 |
| 15 | −27.2379 | 1.2000 | 1.90128 | 37.61 |
| 16 | 95.4592 | DD[16] | | |
| *17 | 67.9299 | 4.3522 | 1.49710 | 81.56 |
| *18 | −103.0682 | 1.9773 | | |
| 19 | 71.1528 | 2.4107 | 1.90366 | 31.31 |
| 20 | 35.2832 | 5.7849 | 1.43700 | 95.10 |
| 21 | −180.7488 | 0.1252 | | |
| 22 | 63.7876 | 4.7937 | 1.72236 | 55.27 |
| 23 | 149.3313 | DD[23] | | |
| 24(St) | ∞ | 0.9503 | | |
| 25 | 37.5810 | 1.6733 | 1.81572 | 39.35 |
| 26 | 15.2710 | 6.6424 | 1.57791 | 45.89 |
| 27 | −151.3683 | 0.1255 | | |
| 28 | ∞ | 1.2008 | 1.65972 | 32.84 |
| 29 | 68.2869 | 0.1202 | | |
| 30 | 15.6699 | 1.9110 | 1.65890 | 33.15 |
| 31 | 19.7695 | 3.2400 | | |
| 32 | 3268.5462 | 1.0102 | 1.86670 | 41.29 |
| 33 | 54.1396 | 1.6443 | 1.90999 | 19.46 |
| 34 | 406.7660 | 0.1681 | | |

TABLE 29B
Example 8

| Sn | R | D | Nd | νd |
|---|---|---|---|---|
| 35 | 2739.8343 | 1.0023 | 1.85533 | 42.47 |
| 36 | 21.9834 | 21.9800 | | |
| *37 | 74.2539 | 2.5367 | 1.66808 | 32.38 |
| *38 | −21.0962 | 0.6103 | | |
| 39 | 50.6304 | 3.4605 | 1.49700 | 81.54 |
| 40 | −14.3385 | 1.2003 | 1.88300 | 40.76 |
| 41 | −75.1769 | 0.3353 | | |
| 42 | 29.8340 | 1.2050 | 1.77126 | 46.32 |
| 43 | 12.1786 | 1.6080 | | |
| 44 | ∞ | 1.0000 | 1.51680 | 64.20 |
| 45 | ∞ | 0.1202 | | |
| 46 | ∞ | 1.2001 | 1.77361 | 26.35 |
| 47 | 49.2112 | 2.0540 | 1.46106 | 59.97 |
| 48 | −29.8442 | 5.0000 | | |
| 49 | ∞ | 1.0000 | 1.51633 | 64.05 |
| 50 | ∞ | 13.5348 | | |

TABLE 30
Example 8

| | Wide | Tele |
|---|---|---|
| Zr | 1.00 | 67.00 |
| f | 14.55 | 974.71 |
| Bf | 19.20 | 19.20 |
| FNo. | 2.8 | 9.0 |
| 2ω[°] | 34.6 | 0.6 |
| Y | 4.65 | |

TABLE 31
Example 8

| | Wide | Tele |
|---|---|---|
| DD[8] | 8.36 | 104.62 |
| DD[10] | 6.20 | 7.99 |
| DD[16] | 169.72 | 1.00 |
| DD[23] | 3.00 | 73.67 |

TABLE 32
Example 8

| Sn | 9 | 10 | 17 | 18 |
|---|---|---|---|---|
| KA | 1.0000000E+00 | 1.0000000E+00 | 1.0000000E+00 | 1.0000000E+00 |
| A3 | −3.3506979E−05 | −4.1947806E−05 | −7.2380689E−07 | 1.1477942E−05 |
| A4 | 3.8772004E−06 | 6.7636592E−06 | 5.1011622E−06 | 4.2954118E−07 |
| A5 | 1.3659732E−06 | 7.4531458E−07 | −3.6044505E−07 | 4.4680692E−07 |
| A6 | −1.2098298E−07 | −7.6286039E−09 | −4.4084764E−08 | −9.0520363E−09 |
| A7 | −1.4221786E−08 | −1.9114011E−08 | 4.9519053E−10 | −2.5240941E−08 |
| A8 | 2.1686870E−09 | 1.5716021E−10 | 2.5581898E−10 | 1.6991514E−09 |
| A9 | 8.5288485E−11 | 3.7058990E−10 | 1.4266303E−10 | 4.4883619E−10 |
| A10 | −2.2196059E−11 | −1.4354194E−11 | −4.2717365E−12 | −3.9141069E−11 |
| A11 | −3.0207759E−13 | −3.8033805E−12 | −2.7963917E−12 | −4.0154733E−12 |
| A12 | 1.4992837E−13 | 2.2648616E−13 | 9.7995221E−14 | 4.1089101E−13 |
| A13 | 5.5923509E−16 | 2.1765504E−14 | 2.4512115E−14 | 2.0239347E−14 |
| A14 | −6.8021877E−16 | −1.6249905E−15 | −1.0424041E−15 | −2.3788912E−15 |
| A15 | −5.9213595E−20 | −7.0506253E−17 | −1.1284843E−16 | −5.8035538E−17 |
| A16 | 1.9672051E−18 | 6.1447931E−18 | 5.4388715E−18 | 7.8552135E−18 |
| A17 | −1.7778839E−21 | 1.2145789E−19 | 2.6549765E−19 | 8.7744184E−20 |
| A18 | −3.2357388E−21 | −1.1949993E−20 | −1.3876143E−20 | −1.3892084E−20 |
| A19 | 2.2611342E−24 | −8.7064461E−23 | −2.5217851E−22 | −5.3929200E−23 |
| A20 | 2.2843593E−24 | 9.4527171E−24 | 1.3895798E−23 | 1.0221046E−23 |

| Sn | 37 | 38 |
|---|---|---|
| KA | 1.0000000E+00 | 1.0000000E+00 |
| A3 | −1.7900918E−04 | −3.6884400E−04 |
| A4 | −1.2063608E−05 | 8.0202843E−05 |
| A5 | 7.2691781E−05 | 3.7038804E−05 |
| A6 | −7.4366626E−06 | −8.0382185E−06 |
| A7 | −1.0592293E−05 | −4.0157946E−06 |
| A8 | 1.6600674E−06 | 5.3295681E−07 |
| A9 | 7.5539135E−07 | 3.1253409E−07 |
| A10 | −1.3674552E−07 | −2.3987711E−08 |
| A11 | −3.0280612E−08 | −1.4995437E−08 |
| A12 | 5.9551576E−09 | 7.2265832E−10 |
| A13 | 7.2161951E−10 | 4.4298015E−10 |
| A14 | −1.5064601E−10 | −1.4272840E−11 |
| A15 | −1.0169480E−11 | −7.9304054E−12 |
| A16 | 2.2293537E−12 | 1.8739089E−13 |
| A17 | 7.8362797E−14 | 7.9465250E−14 |
| A18 | −1.7957293E−14 | −1.6627859E−15 |
| A19 | −2.5481720E−16 | −3.4340395E−16 |
| A20 | 6.0963610E−17 | 7.9408885E−18 |

Tables 33 and 34 each show corresponding values of Conditional Expressions (1) to (11) of the zoom lenses of Examples 1 to 8. Preferable ranges of the conditional expressions may be set by using the corresponding values of the examples shown in Tables 33 and 34 as the upper or lower limits of the conditional expressions.

TABLE 33

| Expression | | | | | |
|---|---|---|---|---|---|
| Number | | Example 1 | Example 2 | Example 3 | Example 4 |
| (1) | (ft/fw)/Movmax | 1.20 | 1.27 | 0.60 | 0.57 |
| (2) | TL/2Y | 65.66 | 66.87 | 67.36 | 82.67 |
| (3) | ft/TL | 2.71 | 3.09 | 2.83 | 2.70 |
| (4) | ft/Bf | 102.16 | 105.52 | 71.02 | 79.62 |
| (5) | ft/2Y | 88.91 | 103.33 | 95.20 | 111.80 |
| (6) | ft/fF1 | 7.57 | 8.11 | 4.60 | 4.37 |
| (7) | \|ft/fM11\| | 38.56 | 44.16 | 35.85 | 41.72 |
| (8) | ft/fR1 | 9.16 | 9.56 | 28.33 | 31.15 |
| (9) | ft/fRe | −2.90 | −6.00 | 40.10 | 38.94 |
| (10) | \|(1 − βfoc²) × βfocR²\| | 0.51 | 0.80 | 18.55 | 17.47 |
| (11) | \|(1 − βM1²) × βM1R²\| | 56.94 | 65.74 | 0.71 | 1.70 |

TABLE 34

| Expression | | | | | |
|---|---|---|---|---|---|
| Number | | Example 5 | Example 6 | Example 7 | Example 8 |
| (1) | (ft/fw)/Movmax | 0.49 | 0.61 | 0.62 | 0.68 |
| (2) | TL/2Y | 64.18 | 64.18 | 64.59 | 75.55 |
| (3) | ft/TL | 2.77 | 3.25 | 2.76 | 2.77 |
| (4) | ft/Bf | 68.67 | 79.66 | 65.60 | 50.78 |
| (5) | ft/2Y | 88.73 | 104.32 | 88.98 | 104.81 |
| (6) | ft/fF1 | 4.29 | 5.36 | 1.64 | 5.75 |
| (7) | \|ft/fM1\| | 41.67 | 49.83 | 44.55 | 10.04 |
| (8) | ft/fR1 | 26.99 | 28.68 | 19.93 | 19.55 |
| (9) | ft/fRe | −0.01 | −0.01 | −9.00 | −4.57 |
| (10) | \|(1 − βfoc²) × βfocR²\| | 5.64 | 7.03 | 3.35 | 4.41 |
| (11) | \|(1 − βM1²) × βM1R²\| | 0.24 | 0.24 | 21.70 | 21.11 |

All of the zoom lenses of Examples 1 to 8 are configured to have a small size, achieve a zoom ratio of 40 or more, and have a high zoom ratio. Further, various aberrations of all the zoom lenses of Examples 1 to 8 are satisfactorily corrected to maintain high optical performance. The zoom ratio of the zoom lens of the present disclosure is preferably 50 or more, more preferably 55 or more, and yet more preferably 57 or more.

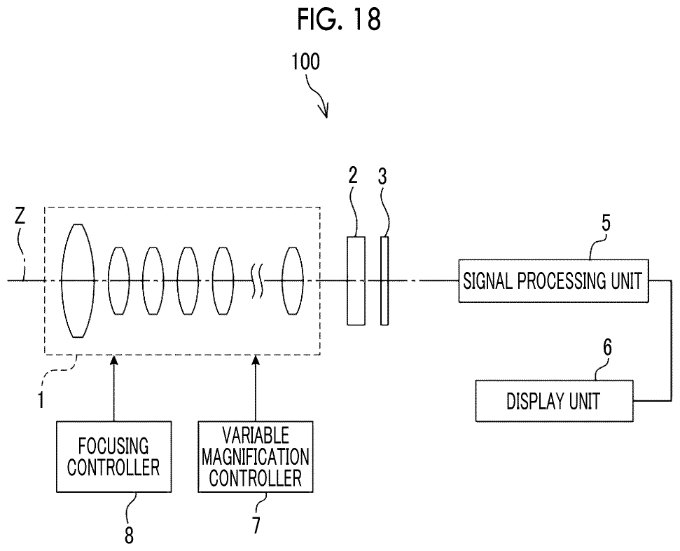

Next, an imaging apparatus according to an embodiment of the present disclosure will be described. FIG. 18 is a schematic configuration diagram of an imaging apparatus 100 according to an embodiment of the present disclosure. The imaging apparatus 100 is configured to include a zoom lens 1 according to an embodiment of the present disclosure. Examples of the imaging apparatus 100 may include a surveillance camera, a broadcast camera, a movie camera, a video camera, and the like.

The imaging apparatus 100 includes a zoom lens 1, a filter 2 disposed on the image side of the zoom lens 1, and an imaging element 3 disposed on the image side of the filter 2. It should be noted that FIG. 18 schematically shows a plurality of lenses included in the zoom lens 1.

The imaging element 3 converts an optical image formed by the zoom lens 1 into an electric signal, and for example, a charge coupled device (CCD) or a complementary metal oxide semiconductor (CMOS) or the like can be used. The imaging element 3 is disposed such that the imaging surface thereof coincides with the image plane of the zoom lens 1.

The imaging apparatus 100 further comprises a signal processing unit 5, a display unit 6, a zoom controller 7, and a focusing controller 8. The signal processing unit 5 performs calculation processing on an output signal from the imaging element 3. The display unit 6 displays an image formed by the signal processing unit 5. The zoom controller 7 controls zooming of the zoom lens 1. The focusing controller 8 controls focusing of the zoom lens 1. It should be noted that although FIG. 18 shows only one imaging element 3, a so-called three-plate-type imaging apparatus having three imaging elements may be used.

The technique of the present disclosure has been hitherto described through embodiments and examples, but the technique of the present disclosure is not limited to the above-mentioned embodiments and examples, and may be modified into various forms. For example, values such as the curvature radius, the surface spacing, the refractive index, the Abbe number, and the aspherical coefficient of each lens are not limited to the values shown in the examples, and different values may be used therefor.

Regarding the above-mentioned embodiments and examples, the following Supplementary Notes will be further disclosed.

### Supplementary Note 1

A zoom lens consisting of, in order from an object side to an image side:
a front group; an intermediate group; and a rear group,
in which the front group consists of two or fewer lens groups that have positive refractive powers,
a lens group closest to the object side in the front group remains stationary with respect to an image plane during zooming,
the intermediate group consists of two or fewer lens groups that have negative refractive powers,
the rear group consists of a plurality of lens groups,
a lens group closest to the object side in the rear group has a positive refractive power,
a lens group closest to the image side in the rear group remains stationary with respect to the image plane during zooming,
all spacings of adjacent lens groups change during zooming, and
assuming that
   a focal length of a whole system in a state where an infinite distance object is in focus at a telephoto end is ft,
   a focal length of the whole system in a state where the infinite distance object is in focus at a wide-angle end is fw,
   an amount of displacement of a lens group, which has a maximum amount of displacement during zooming from the wide-angle end to the telephoto end, among lens groups that move during zooming, is Movmax, and
   a unit of Movmax is mm,
   Conditional Expression (1) is satisfied, which is represented by

$$0.4 < ( ft / fw ) Mov max . \qquad ( 1 )$$

### Supplementary Note 2

The zoom lens according to Supplementary Note 1, in which assuming that a sum of a back focal length of the whole system in terms of an air-equivalent distance and a distance on an optical axis from a lens surface closest to the object side in the front group to a lens surface closest to the image side in the rear group in a state where the infinite distance object is in focus is TL, and a maximum image height is Y, Conditional Expression (2) is satisfied, which is represented by

$$TL / 2 Y < 80. \qquad ( 2 )$$

### Supplementary Note 3

The zoom lens according to Supplementary Note 1 or 2, in which assuming that a sum of a back focal length of the whole system in terms of an air-equivalent distance and a distance on an optical axis from a lens surface closest to the object side in the front group to a lens surface closest to the image side in the rear group in a state where the infinite distance object is in focus is TL, Conditional Expression (3) is satisfied, which is represented by

$$2 < ft / TL . \qquad ( 3 )$$

### Supplementary Note 4

The zoom lens according to any one of Supplementary Notes 1 to 3, in which assuming that a back focal length of the whole system in terms of an air-equivalent distance is Bf, Conditional Expression (4) is satisfied, which is represented by

$$10 < ft / BF . \qquad ( 4 )$$

### Supplementary Note 5

The zoom lens according to any one of Supplementary Notes 1 to 4, in which assuming that a maximum image height is Y, Conditional Expression (5) is satisfied, which is represented by

$$30 < ft / 2 Y . \qquad ( 5 )$$

### Supplementary Note 6

The zoom lens according to any one of Supplementary Notes 1 to 5, in which assuming that a focal length of the lens group closest to the object side in the front group is fF1, Conditional Expression (6) is satisfied, which is represented by

$$0.5 < ft / fF 1. \qquad ( 6 )$$

### Supplementary Note 7

The zoom lens according to any one of Supplementary Notes 1 to 6, in which assuming that a focal length of a lens group closest to the object side in the intermediate group is fM1, Conditional Expression (7) is satisfied, which is represented by

$$5 < \vert ft / fM 1 \vert . \qquad ( 7 )$$

### Supplementary Note 8

The zoom lens according to any one of Supplementary Notes 1 to 7,
in which the lens group closest to the object side in the front group includes at least four lenses, and
a lens group which is third from the object side in the rear group includes an aspherical lens.

### Supplementary Note 9

The zoom lens according to any one of Supplementary Notes 1 to 8, in which assuming that a focal length of the lens group closest to the object side in the rear group is fR1, Conditional Expression (8) is satisfied, which is represented by

$$0 < ft / fR 1 < 100. \qquad ( 8 )$$

### Supplementary Note 10

The zoom lens according to any one of Supplementary Notes 1 to 9, in which assuming that a focal length of the lens group closest to the image side in the rear group is fRe, Conditional Expression (9) is satisfied, which is represented by

$$- 100 < ft / fRe < 200. \qquad ( 9 )$$

### Supplementary Note 11

The zoom lens according to Supplementary Note 10, in which Conditional Expression (9-1) is satisfied, which is represented by

$$0 < ft / fRe < 200. \qquad ( 9 - 1 )$$

### Supplementary Note 12

The zoom lens according to Supplementary Note 10, in which Conditional Expression (9-6) is satisfied, which is represented by

$$- 100 < ft / fRe < 0. \qquad ( 9 - 6 )$$

### Supplementary Note 13

The zoom lens according to any one of Supplementary Notes 1 to 12,
in which the zoom lens includes a focusing group that moves during focusing, and assuming that
   a lateral magnification of the focusing group in a state where the infinite distance object is in focus at the telephoto end is βfoc, and
   a combined lateral magnification of all lenses closer to the image side than the focusing group in a state where the infinite distance object is in focus at the telephoto end is βfocR,
   Conditional Expression (10) is satisfied, which is represented by

$$\vert ( 1 - β {foc}^{2} ) \times β {focR}^{2} \vert < 50. \qquad ( 10 )$$

### Supplementary Note 14

The zoom lens according to any one of Supplementary Notes 1 to 13, in which the lens group closest to the object side in the front group includes at least one cemented lens.

### Supplementary Note 15

The zoom lens according to any one of Supplementary Notes 1 to 14, in which the lens group closest to the object side in the front group includes at least one positive lens that has an Abbe number of 70 or more based on a d-line.

### Supplementary Note 16

The zoom lens according to any one of Supplementary Notes 1 to 15, in which the lens group closest to the object side in the front group includes at least one negative lens that has an Abbe number of 60 or less based on a d-line.

### Supplementary Note 17

The zoom lens according to any one of Supplementary Notes 1 to 16, in which a lens group closest to the object side in the intermediate group includes at least one positive lens that has an Abbe number of 40 or less based on a d-line.

### Supplementary Note 18

The zoom lens according to any one of Supplementary Notes 1 to 17, in which a lens group closest to the object side in the intermediate group includes at least one positive lens and at least two negative lenses.

### Supplementary Note 19

The zoom lens according to any one of Supplementary Notes 1 to 18, in which Conditional Expression (1-1) is satisfied, which is represented by

$$0.8 < ( ft / fw ) / Movmax . \qquad ( 1 - 1 )$$

### Supplementary Note 20

An imaging apparatus comprising: the zoom lens according to any one of Supplementary Notes 1 to 19.

What is claimed is:

1. A zoom lens consisting of, in order from an object side to an image side:
a front group; an intermediate group; and a rear group,
wherein the front group consists of two or fewer lens groups that have positive refractive powers,
a lens group closest to the object side in the front group remains stationary with respect to an image plane during zooming,
the intermediate group consists of two or fewer lens groups that have negative refractive powers,
the rear group consists of a plurality of lens groups,
a lens group closest to the object side in the rear group has a positive refractive power,
a lens group closest to the image side in the rear group remains stationary with respect to the image plane during zooming,
all spacings of adjacent lens groups change during zooming, and
assuming that
a focal length of the zoom lens in a state where an infinite distance object is in focus at a telephoto end is ft,
a focal length of the zoom lens in a state where the infinite distance object is in focus at a wide-angle end is fw,
an amount of displacement of a lens group, which has a maximum amount of displacement during zooming from the wide-angle end to the telephoto end, among lens groups that move during zooming, is Movmax, and
a unit of Movmax is mm,
Conditional Expression (1) is satisfied, which is represented by
$$0.4 < ( ft / fw ) / Movmax . \qquad ( 1 )$$

2. The zoom lens according to claim 1,
wherein assuming that a sum of a back focal length of the zoom lens in terms of an air-equivalent distance and a distance on an optical axis from a lens surface closest to the object side in the front group to a lens surface closest to the image side in the rear group in a state where the infinite distance object is in focus is TL, and a maximum image height is Y, Conditional Expression (2) is satisfied, which is represented by
$$TL / 2 Y < 80. \qquad ( 2 )$$

3. The zoom lens according to claim 1,
wherein Conditional Expression (1-1) is satisfied, which is represented by
$$0.8 < ( ft / fw ) / Movmax . \qquad ( 1 - 1 )$$

4. The zoom lens according to claim 1,
wherein assuming that a sum of a back focal length of the zoom lens in terms of an air-equivalent distance and a distance on an optical axis from a lens surface closest to the object side in the front group to a lens surface closest to the image side in the rear group in a state where the infinite distance object is in focus is TL, Conditional Expression (3) is satisfied, which is represented by
$$2 < ft / TL . \qquad ( 3 )$$

5. The zoom lens according to claim 1,
wherein assuming that a back focal length of the zoom lens in terms of an air-equivalent distance is Bf, Conditional Expression (4) is satisfied, which is represented by
$$10 < ft / Bf . \qquad ( 4 )$$

6. The zoom lens according to claim 1,
wherein assuming that a maximum image height is Y, Conditional Expression (5) is satisfied, which is represented by
$$30 < ft / 2 Y . \qquad ( 5 )$$

7. The zoom lens according to claim 1,
wherein assuming that a focal length of the lens group closest to the object side in the front group is fF1, Conditional Expression (6) is satisfied, which is represented by
$$0.5 < ft / fF 1. \qquad ( 6 )$$

8. The zoom lens according to claim 1,
wherein assuming that a focal length of a lens group closest to the object side in the intermediate group is fM1, Conditional Expression (7) is satisfied, which is represented by
$$5 < \vert ft / fM 1 \vert . \qquad ( 7 )$$

9. The zoom lens according to claim 1,
wherein the lens group closest to the object side in the front group includes at least four lenses, and
a lens group which is third from the object side in the rear group includes an aspherical lens.

10. The zoom lens according to claim 1,
wherein assuming that a focal length of the lens group closest to the object side in the rear group is fR1, Conditional Expression (8) is satisfied, which is represented by
$$0 < ft / fR 1 < 100. \qquad ( 8 )$$

11. The zoom lens according to claim 1,
wherein assuming that a focal length of the lens group closest to the image side in the rear group is fRe, Conditional Expression (9) is satisfied, which is represented by
$$- 100 < ft / fRe < 200. \qquad ( 9 )$$

12. The zoom lens according to claim 11,
wherein Conditional Expression (9-1) is satisfied, which is represented by
$$0 < ft / fRe < 200. \qquad ( 9 - 1 )$$

13. The zoom lens according to claim 11,
wherein Conditional Expression (9-6) is satisfied, which is represented by
$$- 100 < ft / fRe < 0. \qquad ( 9 - 6 )$$

14. The zoom lens according to claim 1,
wherein the zoom lens includes a focusing group that moves during focusing, and assuming that
a lateral magnification of the focusing group in a state where the infinite distance object is in focus at the telephoto end is βfoc, and
a combined lateral magnification of all lenses closer to the image side than the focusing group in a state where the infinite distance object is in focus at the telephoto end is βfocR,
Conditional Expression (10) is satisfied, which is represented by
$$\vert ( 1 - β {foc}^{2} ) \times β {focR}^{2} \vert < 50. \qquad ( 10 )$$

15. The zoom lens according to claim 1,
wherein the lens group closest to the object side in the front group includes at least one cemented lens.

16. The zoom lens according to claim 1,
wherein the lens group closest to the object side in the front group includes at least one positive lens that has an Abbe number of 70 or more based on a d-line.

17. The zoom lens according to claim 1,
wherein the lens group closest to the object side in the front group includes at least one negative lens that has an Abbe number of 60 or less based on a d-line.

18. The zoom lens according to claim 1,
wherein a lens group closest to the object side in the intermediate group includes at least one positive lens that has an Abbe number of 40 or less based on a d-line.

19. The zoom lens according to claim 1,
wherein a lens group closest to the object side in the intermediate group includes at least one positive lens and at least two negative lenses.

20. An imaging apparatus comprising: the zoom lens according to claim 1.
